(19) United States
(12) Patent Application Publication
(10) Pub. No.: US 2026/0101218 A1
(43) Pub. Date: Apr. 9, 2026

(54) CROSS-LINK INTERFERENCE REPORTING

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US); Jae Ho RYU, San Diego, CA (US)

(21) Appl. No.: 19/309,381

(22) Filed: Aug. 25, 2025

Related U.S. Application Data
(60) Provisional application No. 63/703,626, filed on Oct. 4, 2024.

(51) Int. Cl. H04W 24/10; H04B 17/318

(52) U.S. Cl. CPC H04W 24/10; H04B 17/328

(57) ABSTRACT

Aspects relate to cross-link interference (CLI) reporting from UEs. A layer 1 (L1) CLI report may be generated and transmitted by a UE to a network entity to report the CLI caused by transmission of at least one signal sent from at least one other UE on at least one CLI measurement resource in a full-duplex or sub-band full-duplex mode. The L1 CLI report may include a plurality of CLI resource indexes, each identifying a different respective CLI measurement resource, an absolute CLI reported value indicative an absolute CLI level and associated with a first CLI resource index, and a plurality of differential CLI reported values associated with other CLI resource indexes and indicative of a respective differential CLI level with respect to the absolute CLI level.

### CROSS-REFERENCE TO RELATED APPLICATIONS

The present Application for Patent claims priority to and the benefit of pending U.S. Provisional Application No. 63/703,626, filed Oct. 4, 2024, and assigned to the assignee hereof and hereby expressly incorporated by reference herein as if fully set forth below in its entirety and for all applicable purposes.

### TECHNICAL FIELD

The technology discussed below relates generally to wireless communication networks, and more particularly, to reporting of cross-link interference in wireless communication networks.

### INTRODUCTION

In wireless communication systems, such as those specified under standards for 5G New Radio (NR) or 6G, transmissions over an air interface from a network entity (e.g., base station) to one or more user equipment (UEs) (e.g., smartphones) are referred to as downlink (DL) transmissions, while transmissions from a UE to a network entity are referred to as uplink (UL) transmissions. Each of the network entity and the UE may communicate in a half-duplex mode, in which only one node may transmit at a time (e.g., each time resource may be allocated for either a DL transmission or an UL transmission), or a full-duplex mode, in which both nodes may simultaneously transmit (e.g., each time resource may be allocated for both a DL transmission and an UL transmission).

Half-duplex is frequently implemented for wireless links utilizing a time division duplex (TDD) carrier. Full-duplex is frequently implemented for wireless links utilizing paired frequency-division duplex (FDD) carriers that enables the simultaneous transmission of UL and DL signals on two separate frequency bands. Sub-band full duplex (SBFD) is a form of full duplexing that enables the simultaneous transmission of UL and DL signals on non-overlapping frequency resources within the same TDD carrier.

In 5G and 6G wireless systems, SBFD and full-duplex network configurations may suffer from cross-link interference between network entities and between UEs. For example, cross-link interference may result from a DL transmission occurring simultaneously to an UL transmission. In an example, an UL transmission may be originated by one UE at the same time a DL transmission is received by another neighboring UE. In this example, the UL transmission may cause cross-link interference with the DL transmission.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus operable at a user equipment (UE) is provided. The apparatus includes one or more memories, a transceiver, and one or more processors coupled to the one or more memories. The one or more processors are configured to measure cross-link interference (CLI) caused by transmission of at least one signal sent from at least one additional UE on at least one CLI measurement resource in a full-duplex or sub-band full-duplex mode and transmit, via the transceiver, a Layer 1 (L1) CLI report to a network entity. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Another example provides a method operable at a user equipment (UE). The method includes measuring cross-link interference (CLI) caused by transmission of at least one signal sent from at least one additional UE on at least one CLI measurement resource in a full-duplex or sub-band full-duplex mode and transmitting a Layer 1 (L1) CLI report to a network entity. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Another example provides an apparatus at a user equipment (UE) including means for measuring cross-link interference (CLI) caused by transmission of at least one signal sent from at least one additional UE on at least one CLI measurement resource in a full-duplex or sub-band full-duplex mode and means for transmitting a Layer 1 (L1) CLI report to a network entity. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Another example provides a non-transitory computer-readable medium having stored therein instructions executable by one or more processors of a user equipment (UE) to measure cross-link interference (CLI) caused by transmission of at least one signal sent from at least one additional UE on at least one CLI measurement resource in a full-duplex or sub-band full-duplex mode and transmit a Layer 1 (L1) CLI report to a network entity. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Another example provides an apparatus operable at a network entity. The apparatus includes one or more memories and one or more processors coupled to the one or more memories. The one or more processors are configured to cause the network entity to obtain at least one signal sent from at least at least one user equipment (UE) on at least one cross-link interference (CLI) measurement resource in a full-duplex or sub-band full-duplex mode and obtain a Layer 1 (L1) CLI report from a first UE. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Another example provides a method operable at a network entity. The method includes obtaining at least one signal sent from at least at least one user equipment (UE) on at least one cross-link interference (CLI) measurement resource in a full-duplex or sub-band full-duplex mode and obtaining a Layer 1 (L1) CLI report from a first UE. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Another example provides an apparatus at a network entity including means for obtaining at least one signal sent from at least at least one user equipment (UE) on at least one cross-link interference (CLI) measurement resource in a full-duplex or sub-band full-duplex mode and means for obtaining a Layer 1 (L1) CLI report from a first UE. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Another example provides a non-transitory computer-readable medium having stored therein instructions executable by one or more processors of a network entity to obtain at least one signal sent from at least at least one user equipment (UE) on at least one cross-link interference (CLI) measurement resource in a full-duplex or sub-band full-duplex mode and obtain a Layer 1 (L1) CLI report from a first UE. The L1 CLI report includes an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a diagram illustrating an example of a wireless communication system and an access network according to some aspects.

FIG. 2 is a diagram providing a high-level illustration of one example of a configuration of a disaggregated base station according to some aspects.

FIGS. 3A, 3B, 3C, and 3D are diagrams illustrating examples of a first 5G/NR frame, DL channels within a 5G/NR subframe, a second 5G/NR frame, and UL channels within a 5G/NR subframe, respectively.

FIGS. 4A-4C illustrate examples of full-duplex communication in paired and unpaired spectrum according to some aspects.

FIG. 5A is a schematic diagram of a network entity including an antenna array configured for full-duplex communication according to some aspects.

FIG. 5B is a schematic illustration of an example of a time division duplex (TDD) frame structure including both half-duplex and sub-band full-duplex (SBFD) slots using the multi-panel antenna array shown in FIG. 5A according to some aspects.

FIG. 6 is a diagram illustrating an example of cross-link interference according to some aspects.

FIG. 7 is a diagram illustrating an example of cross-link interference measurement and reporting according to some aspects.

FIG. 8 is a diagram illustrating an example of a Layer 1 (L1) cross-link interference (CLI) report according to some aspects.

FIG. 9 is a diagram illustrating an example of a table of absolute CLI reported values according to some aspects.

FIG. 10 is a diagram illustrating another example of a table of absolute CLI reported values according to some aspects.

FIG. 11 is a diagram illustrating an example of a table of differential CLI reported values according to some aspects.

FIG. 12 is a diagram illustrating another example of a table of differential CLI reported values according to some aspects.

FIGS. 13A and 13B are diagrams illustrating examples of a CLI report for out-of-range signals according to some aspects.

FIG. 14 is a block diagram illustrating an example of a hardware implementation for UE employing a processing system according to some aspects.

FIG. 15 is a flow chart of an exemplary process for cross-link interference reporting according to some aspects.

FIG. 16 is a flow chart of another exemplary process for cross-link interference reporting according to some aspects.

FIG. 17 is a block diagram illustrating an example of a hardware implementation for a network entity employing a processing system according to some aspects.

FIG. 18 is a flow chart of another exemplary process for cross-link interference reporting according to some aspects.

FIG. 19 is a flow chart of another exemplary process for cross-link interference reporting according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

Full-duplex (FD) communication systems enable simultaneous downlink (DL) and (UL) transmissions in different or overlapping frequencies. FD communication systems include both traditional FD systems and sub-band full-duplex (SBFD) system. Traditional FD systems use separate, paired frequency-division duplex (FDD) carriers for DL and UL transmissions, whereas SBFD systems use a single time-division duplex (TDD) carrier and separate the TDD carrier into DL sub-bands and UL sub-bands for DL and UL transmissions. FD communication systems increase the UL duty cycle leading to latency reduction (e.g., UL signals may be transmitted in the UL sub-band of SBFD slots or in flexible slots, thus enabling UL latency savings) and UL coverage enhancement. In addition, FD communication systems enhance system capacity, resource utilization, and spectrum efficiency.

Dynamic TDD systems, which may include a combination of half-duplex and SBFD slots, may be deployed to enable flexible and dynamic UL/DL resource adaptation according to UL/DL traffic in a robust manner. However, dynamic TDD systems and traditional FD systems may suffer from cross-link interference (CLI) between network entities and between UEs. For example, CLI may result from the use of different transmission directions between adjacent cells or between UEs in the same or adjacent cells. However, there are not sufficient reporting mechanisms in place to report and manage CLI in current wireless communication systems.

Various aspects are related to reporting CLI experienced by UEs. A CLI report may be generated and transmitted by a UE to a network entity to report the CLI measured by the UE based on transmissions of other nearby UEs within the same cell or a neighboring cell. For example, the UE may be configured to measure the CLI (e.g., reference signal received power (RSRP) or received signal strength indicator (RSSI)) caused by transmission of one or more signals (e.g., sounding reference signals (SRSs) or other signals, including other sidelink signals) transmitted from other nearby UEs.

The CLI report may be, for example, a Layer 1 (L1) CLI report that includes a resource index identifying a CLI measurement resource (e.g., SRS resource indicator (SRSRI) or other CLI resource indicator (CLIRI)) measured by the UE, along with a CLI report quantity (e.g., CLI reported value) indicative of the CLI level measured on the CLI measurement resource. In some examples, the CLI reported value may may an L1-SRS-RSRP or an L1-CLI-RSSI. The L1 CLI report may include a plurality of CLI reported values, each associated with a different respective CLI measurement resource (e.g., different CLI resource index). For example, a UE may measure the CLI caused by transmission of a plurality of signals sent from one or more neighbor UEs on a plurality of CLI measurement resources and include the respective CLI reported values within a single L1 CLI report. In some examples, the L1 CLI report may include four or eight CLI reported values, along with the respective resource indexes associated with each of the CLI reported values. For example, the UE may be configured to report the four or eight most interfering (e.g., highest CLI reported values) in the L1 CLI report or the four or eight least interfering (e.g., lowest CLI reported values) in the L1 CLI report based on a reporting criteria indicating to report the most interfering or the least interfering CLI measurement resources and further based on a UE capability to support four or eight CLI reported values. In some examples, the L1 CLI report may be sent periodically, semi-persistently, or aperiodically (e.g., dynamically).

In some examples, the L1 CLI report may include an absolute CLI reported value indicative of an absolute CLI level for a first resource index identifying a first CLI measurement resource, where the absolute CLI reported value is the highest CLI reported value (most interfering, if the UE is configured to report the highest CLI reported values) or the lowest CLI reported value (least interfering, if the UE is configured to report the lowest CLI reported values). In addition, the L1 CLI report may include differential CLI reported values for each of the remaining resource indexes identifying remaining CLI measurement resources. The differential CLI reported values may be indicative of a differential CLI level with respect to the absolute CLI level. In some examples, the L1 CLI report may include a plurality of resource index fields each configured to include a respective one of a plurality of resource indexes, each identifying a different respective CLI measurement resource of the at least one CLI measurement resource. In addition, the L1 CLI report may include an absolute CLI indicator field associated with a first CLI resource index field of the plurality of CLI resource index fields. The absolute CLI indicator field is configured to include an absolute CLI reported value indicative of an absolute CLI level and. The L1 CLI report may further include a plurality of differential CLI indicator fields associated with additional CLI resource indexes of the plurality of CLI resource indexes. Each of the differential CLI indicator fields is configured to include a respective one of a plurality of differential CLI reported values indicative of a differential CLI level with respect to the absolute CLI level.

In some examples, at least a first reference signal sent on at least a first CLI measurement resource is an out-of-range signal. For example, the first reference signal may have a signal strength that is outside of a CLI measurement range (e.g., an absolute CLI level range) of the UE. In an example, the signal strength may be either higher than a maximum absolute CLI level (and therefore, the first reference signal is a blocking signal too strong to measure) or lower than a minimum absolute CLI level (and therefore, the first reference signal is too weak to measure). In this case, the CLI reported value for the out-of-range signal may be set to an out-of-range code bit (e.g., a blocking code bit or a weak code bit). In this way, the L1 CLI report may be used to indicate the presence of blocking signals or weak signals in the area surrounding the UE. For example, the L1 CLI report may include at least a first CLI resource index identifying at least the first CLI measurement resource and at least a first CLI reported value associated with at least the first CLI resource index set to the out-of-range code bit.

In some examples, the L1 CLI report may further include the first CLI resource index field including the first CLI resource index, the absolute CLI indicator field including the first CLI reported value, each remaining CLI resource index of the additional CLI resource indexes set to a respective dummy value, and each remaining differential CLI reported value of the plurality of differential CLI reported values set to a respective unused code bit to indicate that no differential CLI can be reported (e.g., based on the out-of-range signal having an effective CLI of plus or minus infinity). In this example, although the L1 CLI report may include the CLI resource index associated with the out-of-range signal, the L1 CLI report may not include the actual resource indexes of any other uplink reference signals since differential CLI reported values are not included for the other uplink reference signals. Thus, the other CLI resource indexes in the L1 CLI report may be set to respective dummy values. If more than one out-of-range signal is detected, the L1 CLI report may include the respective CLI resource indexes associated with each of the out-of-range signals, out-of-range code bits for the CLI reported values of each of the out-of-range signals (e.g., to indicate blocking or weak signals), dummy values for any remaining CLI resource indexes, and unused code bits for the differential CLI reported values associated with the remaining CLI resource indexes. In some examples, the out-of-range code bit and the unused code bit are selected from a table of absolute CLI reported values and corresponding absolute CLI levels with 1 dB resolution.

In some examples, instead of setting the remaining CLI resource indexes to dummy values and the remaining differential CLI reported values to unused, the actual remaining CLI resource indexes may be included in the CLI report and the differential CLI reported values may be reported with respect to the maximum or minimum absolute CLI level in the absolute CLI level range (e.g., a CLI-RSRP range or a CLI-RSSI range). In other examples, instead of reporting the out-of-range signal(s) with out-of-range code bit(s) in the absolute CLI indicator field, the next highest (or lowest) in-range signal may be reported in the absolute CLI indicator field and the out-of-range signal may be reported in a differential CLI indicator field. For example, a last differential CLI reported value in the L1 CLI report may be set to the out-of-range code bit and a corresponding last CLI resource index in the L1 CLI report may be set to the first CLI resource index of the out-of-range signal. In some examples, the out-of-range code bit included in the differential CLI indicator field may be selected from a table of differential CLI reported values, each representing a range with 2 dB resolution of differential CLI levels with respect to the absolute CLI level and each having four or five bits.

In some examples, the L1 CLI report may include a single bit indicating whether one or more out-of-range signals are included in the L1 CLI report. In this example, if the bit is set to one, indicating that one or more out-of-range signals are included in the L1 CLI report, the CLI resource index(es) associated with the out-of-range signal(s) can be included in the L1 CLI report, remaining CLI resource indexes may be set to dummy values, and the absolute CLI reported value and differential CLI reported values may be excluded from the payload of the L1 CLI report, thus reducing the payload size of the L1 CLI report. It is understood that the L1 CLI report being configured to include the absolute CLI reported value and any differential CLI reported values entails that the L1 CLI report may, in some circumstances, not include, e.g. exclude, the absolute CLI reported value and any differential CLI reported values so long as it is configured to be capable of including said values.

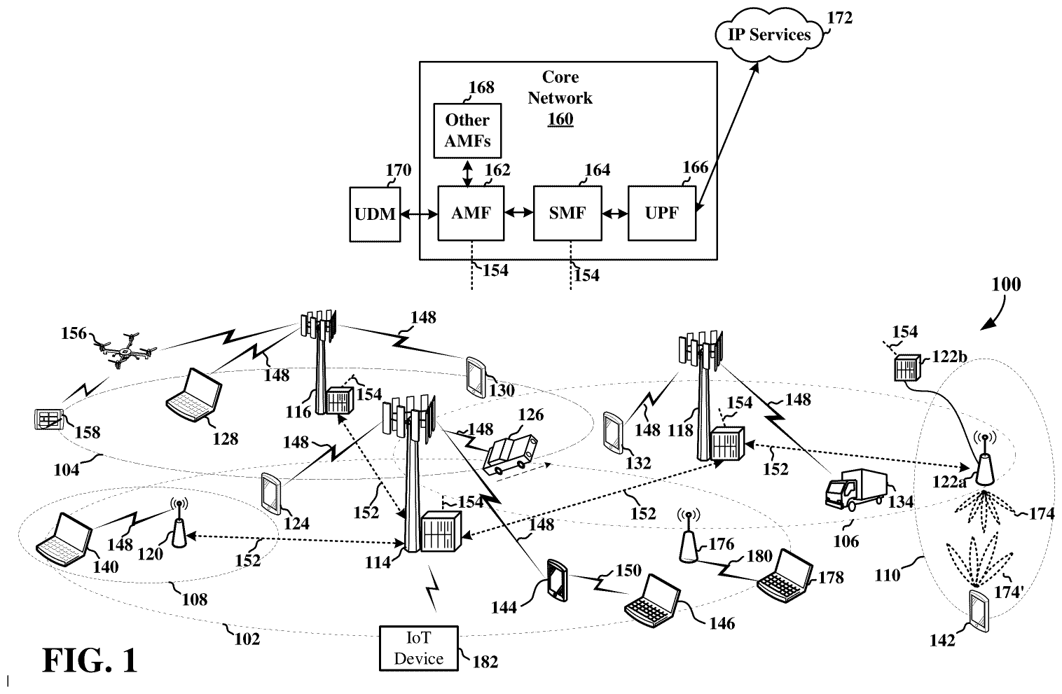

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

In some examples, a UE may correspond to an IoT device 182. The IoT device 182 may include, for example, a passive IoT device, such as a radio frequency identification (RFID)-type sensor/actuator (SA), a semi-passive IoT device, or an active IoT device. Active IoT devices and semi-active IoT device may include a battery or power source that may be charged, for example, using wireless power transfer (WPT) or, more generally, ambient energy harvesting, whereas passive IoT devices lack an internal power source, and therefore, use ambient energy harvesting to power the device. Semi-passive IoT devices may include a capacitor or other storage device that provides a warm start-up to the energy harvesting in the device. The IoT device 182 may communicate with a network entity (e.g., network entity 114 or RFID reader). In some examples, the network entity 114 may communicate with the IoT device via cellular (Uu) links. For example, the network entity 114 may provide an energy transmission on the downlink to power the IoT device. The energy transmission may further be modulated and backscattered by the IoT device 182 as an information-bearing signal on the uplink. In addition, the network entity 114 may transmit control information and/or data to the IoT device 182 on the downlink, which may be detected by the IoT device using, for example, envelope detection. In this manner, the network entity 114 may read information from the IoT device 182 and write information to the IoT device 182.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a packet-switched (PS) Streaming Service, and/or other IP services.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

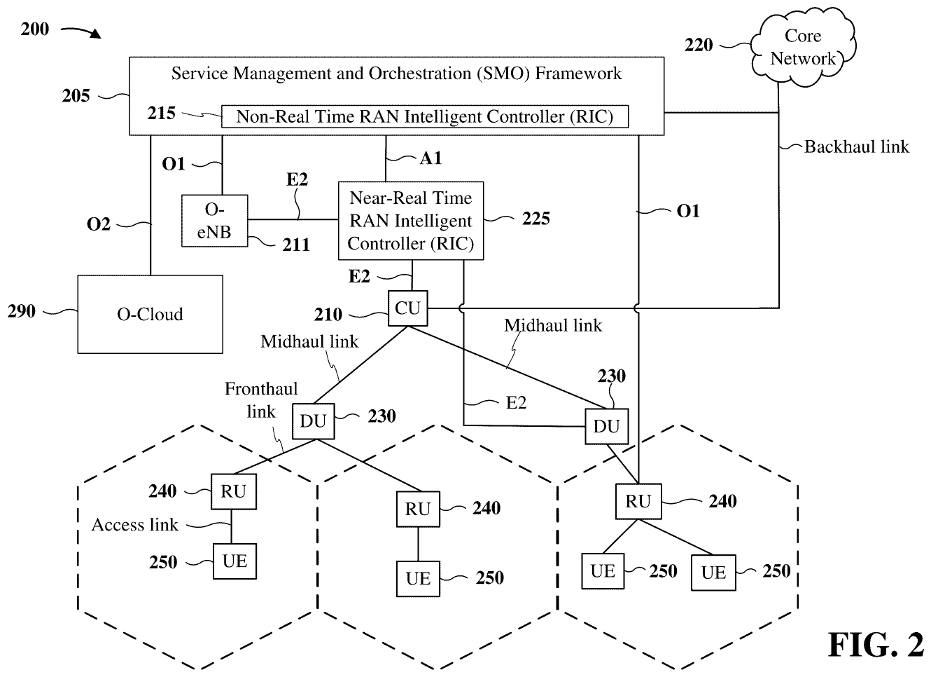

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 2rd Generation Partnership Project (2GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

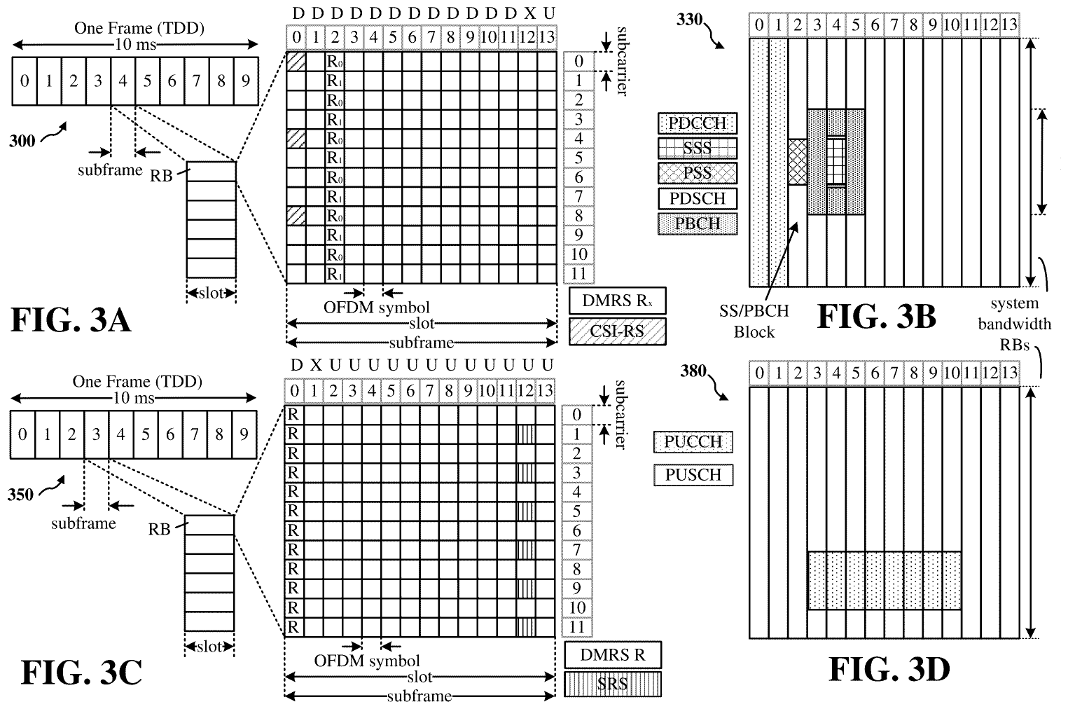

FIG. 3A is a diagram 300 illustrating an example of a first subframe within a 5G/NR frame structure. FIG. 3B is a diagram 330 illustrating an example of DL channels within a 5G/NR subframe. FIG. 3C is a diagram 350 illustrating an example of a second subframe within a 5G/NR frame structure. FIG. 3D is a diagram 380 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 3A, 3C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may further transmit sounding reference signals (SRS). The SRS may be used by a base station (network entity) for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

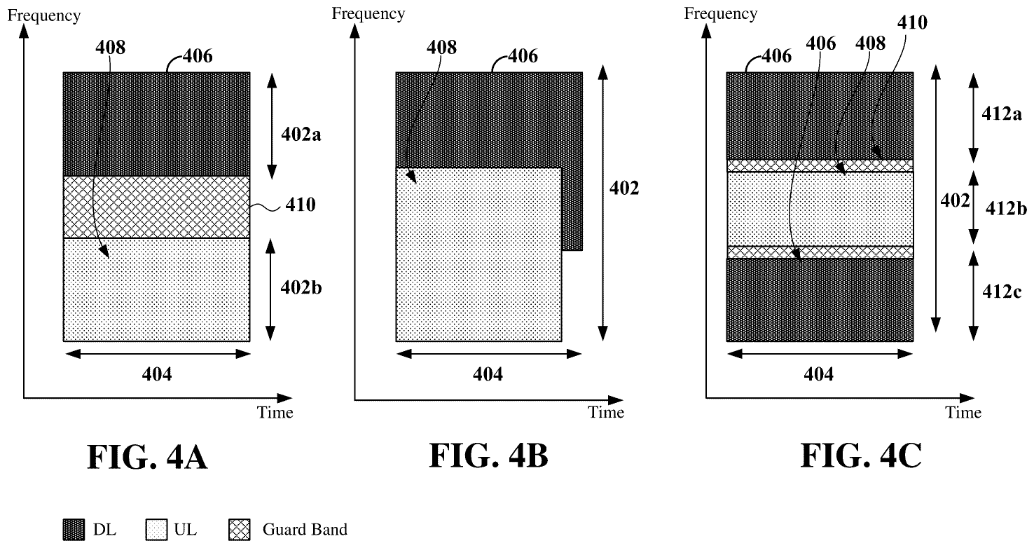

FIGS. 4A-4C illustrate examples of full-duplex communication in paired and unpaired spectrum according to some aspects. FIG. 4A illustrates full-duplex (FD) communication, FIG. 4B illustrates in-band full-duplex (IBFD) communication, and FIG. 4C illustrates sub-band FD communication. For FD communication, as shown in FIG. 4A, downlink and uplink transmissions occur on the same time resources, but different frequency resources. For example, downlink resources 406 (e.g., downlink BWP) allocated for transmissions in the downlink direction overlap in time with uplink resources 408 (e.g., uplink BWP) allocated for transmissions in the uplink direction. However, the downlink resources 406 do not overlap in frequency with the uplink resources 408. Instead, the downlink resources 406 and uplink resources 408 are within different carrier bandwidths (frequency bands) 402a and 402b, each having a different carrier frequency. The downlink and uplink frequency bands 402a and 402b used by FD communication form paired spectrum 402a and 402b separated by a guard band 410. The guard band 410 provides spectrum separation between the downlink and uplink frequency bands 402a and 402b to minimize interference between the two bands 402a and 402b. However, with the scarcity and expense of spectrum, the large unusable guard band 410 in FD communication may be undesirable in some networks.

For IBFD communication, as shown in FIG. 4B, downlink and uplink transmissions occur on the same time and frequency resources within the same carrier bandwidth 402 without the use of a guard band. For example, downlink resources 406 allocated for transmissions in the downlink direction overlap in both time and frequency with uplink resources 408 allocated for transmissions in the uplink direction. The overlap may be full or partial, the latter being illustrated in FIG. 4B. However, IBFD communication may suffer from increased interference, thus requiring the use of expensive filters at the transmitter and receiver.

For sub-band FD communication, as shown in FIG. 4C, the carrier bandwidth 402 (or active BWP(s)) may be divided into sub-bands 412a, 412b, and 412c. Each sub-band 412a-412c may be allocated for communication in a single direction. For example, sub-bands 412a and 412c may be allocated for downlink transmissions, while sub-band 412b may be allocated for uplink transmissions. Thus, downlink resources 406 allocated for transmissions in the downlink direction overlap in time, but not in frequency, with uplink resources 408 allocated for transmissions in the uplink direction. The downlink resources 406 may further be separated from the uplink resources 408 in the frequency domain by respective guard bands 410 to isolate the uplink and downlink transmissions in frequency. The guard bands 410 in SBFD communication are significantly smaller than the guard band 410 utilized in FD communication, thus maximizing use of the spectrum.

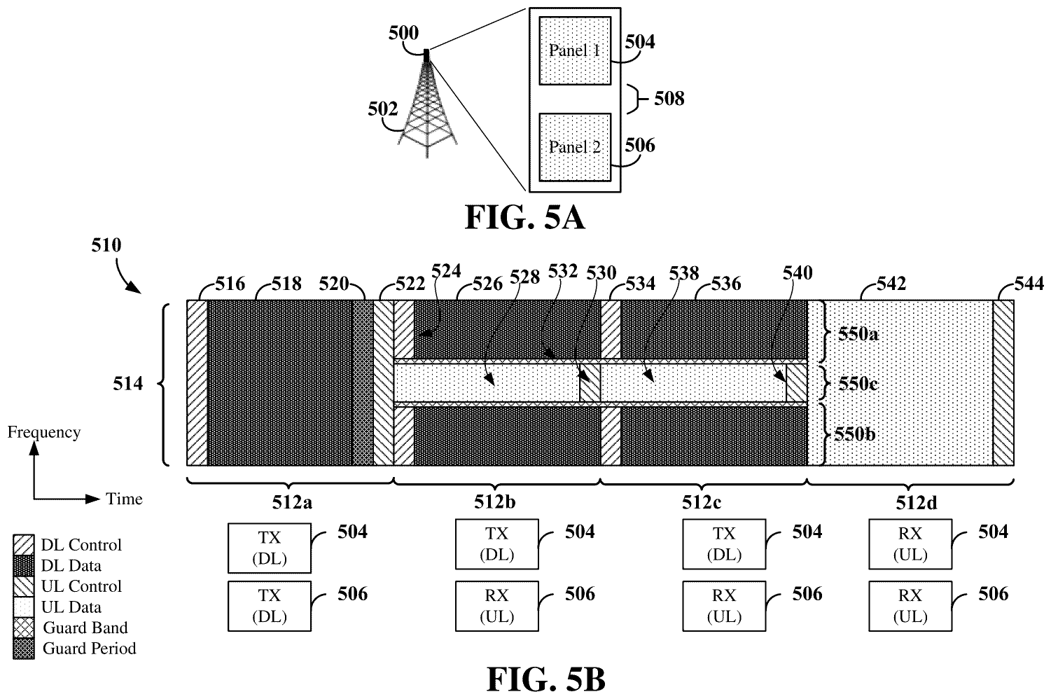

FIG. 5A is a schematic diagram of a network entity 502 (e.g., an aggregated base station, an RU, a DU, a CU, an IAB node or other network device) including an antenna array 500 configured for full-duplex communication according to some aspects. The antenna array 500 is divided into two panels (panel 1 504, panel 2 506) with a physical separation 508 therebetween. Each of the two panels may be a subarray of antennas. A given panel may transmit and/or receive a beam or a beam group. In one example, the panels may be physically separated from one another by a distance selected to provide improved isolation between simultaneous transmission (Tx) and reception (Rx) operations in full-duplex mode, thereby mitigating at least a portion of self-interference resulting from signals being simultaneously transmitted/received. The multi-panel antenna configuration shown in FIG. 5A may also be applicable to UEs to enable full-duplex communication at the UE.

FIG. 5B is schematic illustration of an example of a portion of a TDD frame structure 510 including both half-duplex and sub-band full-duplex (SBFD) slots using, for example, the multi-panel antenna array 500 shown in FIG. 5A according to some aspects. The frame structure 510 may include downlink slots (e.g., including all DL OFDM symbols), uplink slots (e.g., including all UL OFDM symbols), and flexible slots (e.g., including a mix of DL/UL/SBFD OFDM symbols). For example, each OFDM symbol within a slot may be configured as an UL symbol, a DL symbol, or a flexible symbol (e.g., which may be used as an UL symbol, DL symbol, or SBFD symbol) based on a slot format indicator (SFI) for the slot. In the example shown in FIG. 5B, time is in the horizontal direction with units of slots 512a-512d, each including a plurality of OFDM symbols; and frequency is in the vertical direction. Here, a carrier bandwidth 514 (or set of one or more active BWPs) is illustrated along the frequency axis. The carrier bandwidth 514 (or active BWPs) may be divided into a number of sub-bands 550a-550c for sub-band FD full-duplex operation.

In the example shown in FIG. 5B, in slot 512a, the antenna array 500 is first configured for half-duplex downlink (DL) communication (e.g., DL burst 516 and DL data portion 518). The DL burst 516 may include DL control transmitted within the first few symbols of the slot 512a. The DL burst 516 may include, for example, a physical downlink control channel (PDCCH) carrying DCI that may be related to the slot 512a or a previous or subsequent slot. In an example, the DCI may include common DCI or UE-specific DCI. The common DCI may include, for example, common control information broadcast to a group of UEs or all UEs in the cell. The UE-specific DCI may include, for example, HARQ feedback information (e.g., ACK/NACK), scheduling information for scheduling a downlink data transmission and/or uplink transmission in the slot 512a or a subsequent slot (e.g., slot 512b, 512c, and/or 512d), and other suitable information. The DL burst 516 may further include various DL reference signals (e.g., SSB and/or CSI-RS). In this example, both panel 1 504 and panel 2 506 may be configured for DL transmission. The DL data portion 518 may include DL data carried within, for example, a PDSCH. In addition to the DL data, the DL data portion 518 may further include DL reference signals (e.g., DMRS) for use in demodulating and decoding the DL data.

Slot 512a may also include a half-duplex common uplink (UL) burst 522 at the end of slot 512a. The common UL burst 522 may include, for example, a PUCCH carrying UCI or uplink reference signals, such as SRS. As illustrated in FIG. 5B, the end of the DL data portion 518 may be separated in time from the beginning of the UL burst 522. This time separation 520 may sometimes be referred to as a gap, a guard period, a guard interval, and/or various other suitable terms. This separation may provide time for the network entity (e.g., base station) and UE to perform a switch-over between transmitting and receiving, or vice-versa. In this example, both panel 1 504 and panel 2 506 may be configured for UL transmission during the UL burst 522.

In slots 512b and 512c, the antenna array 500 is configured for SBFD communication including both DL communication and UL communication. For example, in slots 512b and 512c, the carrier bandwidth 514 (or active BWP) is shown partitioned between uplink transmissions and downlink transmissions. Sub-bands 550a and 550b are allocated for downlink transmissions, while sub-band 550c is allocated for uplink transmissions. In an example operation of the SBFD configuration shown in FIGS. 5A and 5B, panel 1 504 may be configured for DL transmission at both edges (e.g., sub-bands 550a and 550b) of the carrier bandwidth 514 (or active BWPs) and panel 2 506 may be configured for UL reception in the middle (e.g., sub-band 550c) of the carrier bandwidth 514 (or active BWPs).

In each of the sub-band FD slots 512b and 512c, the DL sub-bands 550a and 550b include a DL burst 524 and 534, respectively, which may include a PDCCH carrying DCI and/or DL reference signals, in the initial portion of the slots 512b and 512c. Following the DL bursts 524 and 534, slots 512b and 512c each include a DL data portion 526 and 536, respectively, for transmitting DL data within sub-bands 550a and 550b. For example, the DL data may be transmitted within a PDSCH. In addition to the DL data, the DL data portions 526 and 536 may further include DL reference signals (e.g., DMRS) for use in demodulating and decoding the DL data.

In the uplink (UL) sub-band 550c, the slots 512b and 512c each include an UL data portion 528 and 538, respectively, for transmitting UL data. For example, the UL data may be transmitted within a PUSCH. Following the UL data portions 528 and 538, the UL sub-band 550c of slots 512b and 512c each include an UL burst 530 and 540, respectively. The UL burst 530 and 540 may include, for example, a PUCCH including UCI or uplink reference signals, such as SRSs. Guard bands 532 are further provided between the UL sub-band 550c and the DL sub-bands 550a and 550b to mitigate self-interference between simultaneous DL transmissions in the DL sub-bands 550a and 550b and UL transmissions in the UL sub-band 550c. Slots 512b and 512c are sub-band full-duplex FDD slots utilizing FDM for multiplexing uplink and downlink transmissions in frequency. The sub-band full-duplex slot configurations shown in FIG. 5 are merely exemplary, and other configurations of sub-band full-duplex slots may be utilized in various aspects of the disclosure.

In slot 512d, the antenna array 500 is configured for half-duplex UL communication. For example, slot 512d includes an UL data portion 542 followed by an UL burst 544. The UL data portion 542 and UL burst 544 may include UL control information and/or UL data, as discussed above. In this example, both panel 1 504 and panel 2 506 may be configured for UL reception. Slots 512a and 512d are half-duplex TDD slots utilizing TDM for multiplexing DL transmissions and UL transmissions in time.

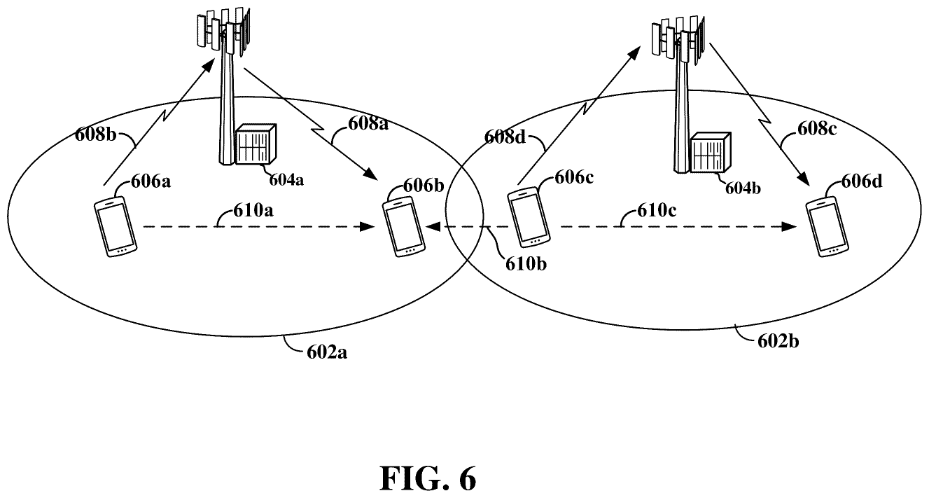

FIG. 6 is a diagram illustrating an example of cross-link interference according to some aspects. In the example shown in FIG. 6, a first cell 602a includes UEs 606a and 606b, each served by a first network entity 604a, while a second cell 602b includes UEs 606c and 606d, each served by a second network entity 604b. Each cell 602a/602b is configured for full-duplex or SBFD communication to enable simultaneous downlink and uplink transmissions between the network entities 604a and 604b and the UEs 606a/606b and 606c/606d. For example, network entity 604a may be configured to transmit a downlink signal 608a to UE 606b, while simultaneously receiving an uplink signal 608b from UE 606a on different paired carriers or different sub-bands of the same unpaired carrier. Similarly, network entity 604b may be configured to transmit a downlink signal 608c to UE 606d, while simultaneously receiving an uplink signal 608d from UE 606c.

CLI may occur between UEs as a result of the transmission of uplink signals 608b and 608d by UEs 606a and 606d at the same time that UEs 606b and 606d are attempting to decode respective downlink signal 608a and 608c. For example, uplink signal 608b may cause intra-cell/inter-UE CLI 610a to occur at UE 606b between the uplink signal 608b and the downlink signal 608a, uplink signal 608d may cause inter-cell/inter-UE CLI 610b to occur at UE 606b between the uplink signal 608d and the downlink signal 608a, and uplink signal 608d may cause intra-cell/inter-UE CLI 610c to occur at UE 606d between the uplink signal 608d and the downlink signal 608c. To effectively manage and minimize CLI between UEs, a CLI measurement and reporting mechanism can be provided to enable UEs to report inter-UE CLI (e.g., intra-cell and/or inter-cell) to the network entities 604a/604b.

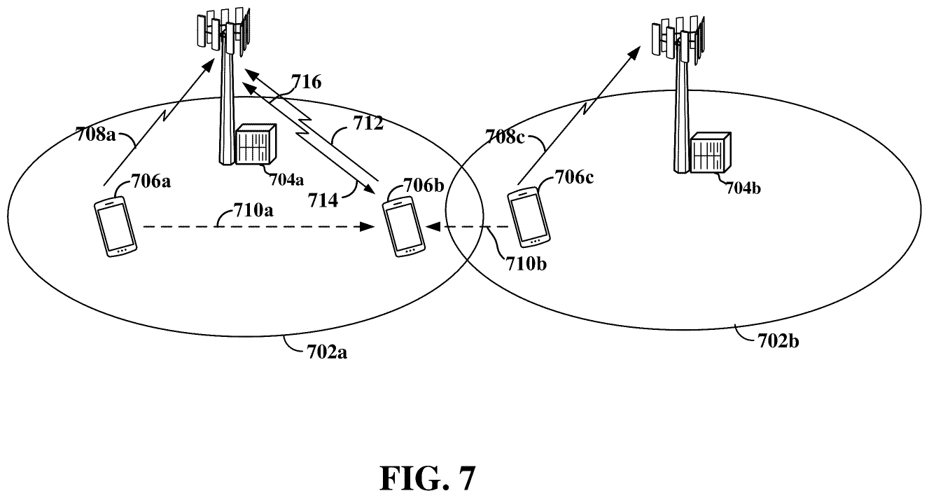

FIG. 7 is a diagram illustrating an example of cross-link interference measurement and reporting according to some aspects. In the example shown in FIG. 7, a first cell 602a includes UEs 706a and 706b, each served by a first network entity 704a, while a second cell 702b includes UE 706c served by a second network entity 704b. Each cell 702a and 702b is configured for full-duplex or SBFD communication to enable simultaneous downlink and uplink transmissions between the network entities 704a and 704b and the UEs 706a/706b and 706c. To minimize the inter-UE CLI in the cells 702a and 702b, a UE (e.g., UE 706b) may be configured to measure and report the inter-UE CLI experienced by the UE 706b on one or more CLI measurement resources (e.g., SRS resources or other uplink/sidelink resources). For example, UE 706b may be configured to measure the CLI caused by transmissions of a first uplink reference signal (e.g., SRS) 708a sent from UE 706a to the network entity 704a on a first CLI measurement resource and a second uplink reference signal 708b sent from UE 706c to the network entity 704b on a second CLI measurement resource. For example, the UE 706b may be configured to measure the reference signal received power (RSRP) of the inter-UE CLI 710a and 710b on each of the CLI measurement resources. In other examples, the UE 706b may be configured to measure the CLI as a received signal strength indicator (RSSI) on each of the CLI measurement resources. The CLI-RSSI may reflect all interference experienced by the UE 706b on the CLI measurement resources.

The UE 706b may then be configured to generate and transmit a Layer 1 (L1) CLI report 712 to the network entity 704a including the measured inter-UE CLI values (e.g., the respective CLI level on each of the CLI measured resources). The CLI report 712 may further include, for example, CLI resource indexes (CLIRIs) identifying the respective CLI measurement resources associated with each of the measured CLI levels. The CLI resource indexes may be used by the network entity 704a to identify the UEs 706a and 706c associated with each of the uplink transmissions 708a and 708b. The network entity 704a may then attempt to mitigate the CLI based on the reported CLI values by, for example, avoiding downlink transmissions to the UE 706b at the same time as uplink transmissions from one or more neighboring UEs (e.g., UE 706a or 706c), increasing the power of downlink transmissions to UE 706b occurring at the same time as uplink transmissions from UE 706a or 706c, or decreasing the power of uplink transmissions from UE 706a or 706c occurring at the same time as downlink transmissions to UE 706b.

In some examples, the L1 CLI report 712 may include a configurable total number (e.g., four or eight) of CLI reported values, along with the respective CLI resource indexes associated with each of the CLI reported values. For example, the UE may be configured to report the four or eight most interfering (e.g., highest CLI reported values) in the L1 CLI report or the four or eight least interfering (e.g., lowest CLI reported values) in the L1 CLI report based on a reporting criteria 716 indicating to report the most interfering or the least interfering CLI measurement resources and further based on a UE capability 714 to support four or eight CLI reported values. For example, the UE 706b may send the UE capability 714 to the network entity indicating a maximum number of CLI reported values supported by the UE. In response, the network entity 704a may send reporting criteria 716 requesting the UE to report of a set of most interfering CLI measurement resources or a set of least interfering CLI measurement resources, along with a total number of CLI reported values to be included in the L1 CLI report based on the UE capability 714. In some examples, the reporting criteria 716 may be sent within a radio resource control (RRC) L1 CLI report configuration. In some examples, the L1 CLI report may be sent periodically, semi-persistently, or aperiodically (e.g., dynamically).

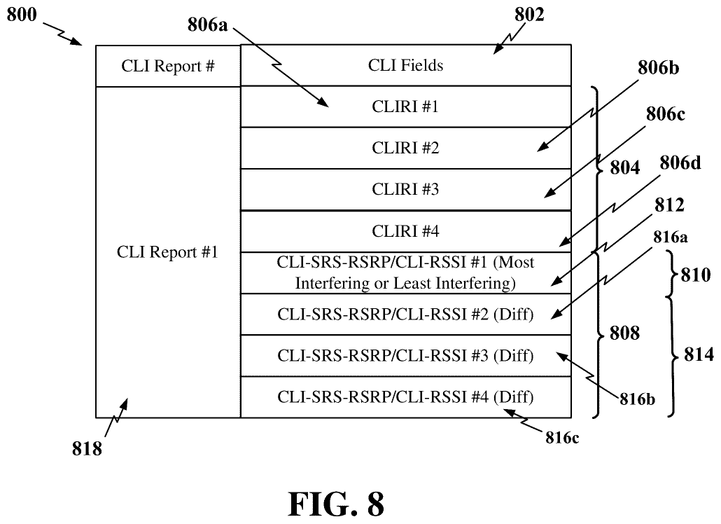

FIG. 8 is a diagram illustrating an example of a Layer 1 (L1) cross-link interference (CLI) report according to some aspects. The L1 CLI report 800 format shown in FIG. 8 includes a plurality of CLI fields 802. The CLI fields 802 may include, for example CLI resource index fields 804 and CLI indicator fields 808. The CLI resource index fields 804 may each be configured to include a respective one of a plurality of CLI resource indexes 806a-806d (e.g., CLIRI #1, CLIRI #2, CLIRI #3, and CLIRI #4), each identifying a different respective CLI measurement resource. The CLI indicator fields 808 include an absolute CLI indicator field 810 and differential CLI indicator fields 814. The absolute CLI indicator field 810 is configured to include an absolute CLI reported value 812 (CLI-SRS-RSRP/CLI-RSSI #1 (Most Interfering or Least Interfering)) associated with a first CLI resource index field (e.g., including CLI resource index 806a) of the plurality of CLI resource index fields 804. Each of the differential CLI indicator fields 814 is configured to include a respective one of a plurality of differential CLI reported values 816a-816c (CLI-SRS-RSRP/CLI-RSSI #2 (Diff), CLI-SRS-RSRP/CLI-RSSI #3 (Diff), and CLI-SRS-RSRP/CLI-RSSI #4 (Diff)), each associated with a respective additional CLI resource index (e.g., CLI resource indexes 806b-806d). For example, differential CLI reported value 816a is associated with the CLI resource index 806b, differential CLI reported value 816b is associated with CLI resource index 806c, and differential CLI reported value 816c is associated with CLI resource index 806d. Each of the plurality of differential CLI reported values 816a-816c is indicative of a differential CLI level with respect to the absolute CLI level. The absolute CLI reported value 812 and the differential CLI reported values 816a-816c may be CLI-SRS-RSRP reported values or CLI-RSSI reported values. Thus, the L1 CLI report 800 may be a L1 CLI-SRS-RSRP report or a L1 CLI-RSSI report.

In the example shown in FIG. 8, the L1 CLI report 800 includes four CLI resource index fields 804 and four corresponding CLI indicator fields 808 enabling the UE to report the CLI measured on four CLI measurement resources. However, the number of CLI resource index fields 804 and corresponding CLI indicator fields 808 is configurable and set by the network entity based on the capability of the UE. The number of CLI resource index fields 804/CLI indicator fields 808 may include, for example, four or eight, but the disclosure is not limited to any particular number of CLI resource index fields 804/CLI indicator fields 808. For example, the UE may send the UE capability to the network entity indicating a maximum number of CLI reported values supported by the UE. In response, the network entity may send a reporting criteria to the UE indicating a total number of CLI reported values (including the absolute CLI reported value 812 and the differential CLI reported values 816a-816c) to be included in the L1 CLI report based on the UE capability. In addition, the reporting criteria may further request the UE to report of a set of most interfering CLI measurement resources or a set of least interfering CLI measurement resources. Thus, the absolute CLI reported value 812 may be the most interfering (e.g., highest measured) CLI level or the least interfering (e.g., lowest measured) CLI level based on the reporting criteria. The UE may be configured to measure and send L1 CLI reports periodically, semi-persistently, or aperiodically. Therefore, the L1 CLI report 800 may further include an L1 CLI report number 818 (CLI Report #1) indicating the number of the L1 CLI report in a series of L1 CLI reports.

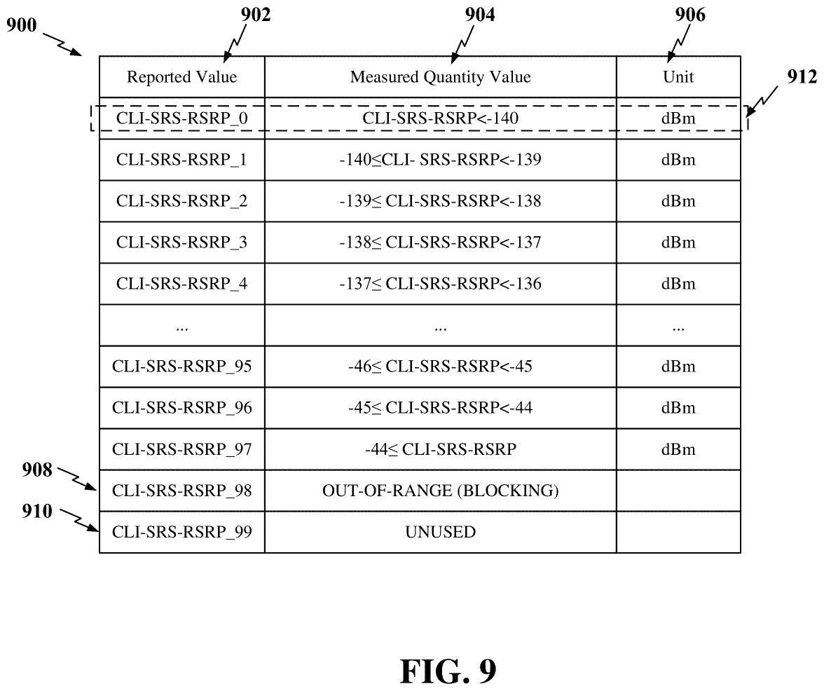

FIG. 9 is a diagram illustrating an example of a table of absolute CLI reported values according to some aspects. The table 900 shown in FIG. 9 includes a plurality of absolute CLI reported values (Reported Value) 902, a corresponding plurality of absolute CLI levels (Measured Quantity Values) 904, and the respective units 906 (e.g., dBm) of each of the CLI levels 904. The absolute CLI levels 904 are represented in the table 900 with 1 dB resolution over a CLI reported value range. In the example shown in FIG. 9, the CLI reported value range is a CLI-SRS-RSRP range such that each of the absolute CLI reported values 902 is an absolute CLI-SRS-RSRP reported value having a respective code bit ranging from 0 to 97, and each of the absolute CLI levels 904 is a measured CLI-SRS-RSRP level with each CSI-SRS-RSRP level quantized to a 7-bit value in the range [−140, −44] dB with 1 dB step size.

In examples in which the reporting criteria indicates the UE should report a set of most interfering CLI measurement resources (e.g., the highest measured four or eight CLI-SRS-RSRP levels), the UE can select the absolute CLI reported value 902 associated with the highest measured CLI level 904 and set the absolute CLI reported value 812 in the absolute CLI indicator field 810 in the L1 CLI report 800 shown in FIG. 8 to the code bit of the absolute CLI reported value 902 associated with the highest measured CLI level 904. The UE can further set the first CLI resource index 806a in the L1 CLI report 800 shown in FIG. 8 to the CLI resource index of the CLI measurement resource on which the highest measured CLI level 904 was obtained. As an example, if the highest measured CLI level 904 is −44 dBm, the UE would set the absolute CLI reported value 812 in the absolute CLI indicator field 810 to the code bit 97 (e.g., CLI-SRS-RSRP_97).

In examples in which the reporting criteria indicates the UE should report a set of least interfering CLI measurement resources (e.g., the lowest measured four or eight CLI-SRS-RSRP levels), the UE can select the absolute CLI reported value 902 associated with the lowest measured CLI level 904 and set the absolute CLI reported value 812 in the absolute CLI indicator field 810 in the L1 CLI report 800 shown in FIG. 8 to the code bit of the absolute CLI reported value 902 associated with the lowest measured CLI level 904. The UE can further set the first CLI resource index 806a in the L1 CLI report 800 shown in FIG. 8 to the CLI resource index of the CLI measurement resource on which the lowest measured CLI level 904 was obtained. As an example, if the lowest measured CLI level 904 is −139 dBm, the UE set the absolute CLI reported value 812 in the absolute CLI indicator field 810 to the code bit 2 (e.g., CLI-SRS-RSRP_2).

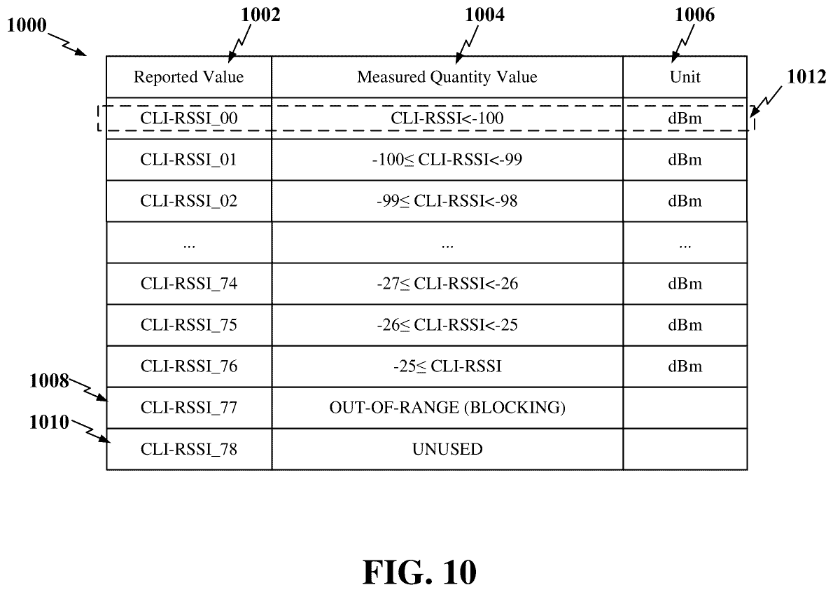

FIG. 10 is a diagram illustrating another example of a table of absolute CLI reported values according to some aspects. The table 1000 shown in FIG. 10 includes a plurality of absolute CLI reported values (Reported Value) 1002, a corresponding plurality of absolute CLI levels (Measured Quantity Values) 1004, and the respective units 1006 (e.g., dBm) of each of the CLI levels 1004. The absolute CLI levels 1004 are represented in the table 1000 with 1 dB resolution over a CLI reported value range. In the example shown in FIG. 10, the CLI reported value range is a CLI-RSSI range such that each of the absolute CLI reported values 1002 is an absolute CLI-RSSI reported value having a respective code bit ranging from 0 to 76, and each of the absolute CLI levels 1004 is a measured CLI-RSSI level with each CSI-RSSI level quantized to a 7-bit value in the range [−100, −25] dBm with 1 dB step size.

In examples in which the reporting criteria indicates the UE should report a set of most interfering CLI measurement resources (e.g., the highest measured four or eight CLI-RSSI levels), the UE can select the absolute CLI reported value 1002 associated with the highest measured CLI level 1004 and set the absolute CLI reported value 812 in the absolute CLI indicator field 810 in the L1 CLI report 800 shown in FIG. 8 to the code bit of the Absolute CLI reported value 1002 associated with the highest measured CLI level 1004. The UE can further set the first CLI resource index 806a in the L1 CLI report 800 shown in FIG. 8 to the CLI resource index of the CLI measurement resource on which the highest measured CLI level 1004 was obtained. As an example, if the highest measured CLI level 1004 is −25 dBm, the UE would set the absolute CLI reported value 812 in the absolute CLI indicator field 810 to the code bit 76 (e.g., CLI-RSSI_76).

In examples in which the reporting criteria indicates the UE should report a set of least interfering CLI measurement resources (e.g., the lowest measured four or eight CLI-RSSI levels), the UE can select the absolute CLI reported value 1002 associated with the lowest measured CLI level 1004 and set the absolute CLI reported value 812 in the absolute CLI indicator field 810 in the L1 CLI report 800 shown in FIG. 8 to the code bit of the Absolute CLI reported value 1002 associated with the lowest measured CLI level 1004. The UE can further set the first CLI resource index 806a in the L1 CLI report 800 shown in FIG. 8 to the CLI resource index of the CLI measurement resource on which the lowest measured CLI level 1004 was obtained. As an example, if the lowest measured CLI level 1004 is −99 dBm, the UE set the absolute CLI reported value 812 in the absolute CLI indicator field 810 to the code bit 02 (e.g., CLI-RSSI_02).

In some examples, if the reporting criteria indicates the UE should report a set of most interfering CLI measurement resources, one or more of the signals (e.g., SRSs or other uplink/sidelink signals) may not be able to be detected by the UE due to a respective signal strength of the one or more signals being higher than a maximum absolute CLI level (e.g., the one or more signals may be blocking signals). For example, the UE may attempt to measure the CLI caused by a first signal on a first CLI measurement resource, but be unable to measure the CLI since the CLI is greater than the maximum absolute CLI level (e.g., −44 dBm for CLI-SRS-RSRP or −25 dBm for CLI-RSSI), and therefore, out-of-range of the UE. To enable the UE to report the presence of one or more blocking out-of-range signals, one of the CLI reported values (code bits) in each of table 900 and table 1000 may be defined to indicate blocking (e.g., one of the code bits may be a blocking out-of-range code bit). For example, in table 900 shown in FIG. 9, the absolute CLI reported value 902 with the code bit CLI-SRS-RSRP_98 may be defined as the out-of-range code bit 908 to indicate blocking of an out-of-range signal. In addition, in table 1000 shown in FIG. 10, the Absolute CLI reported value 1002 with the code bit CLI-RSSI_77 may be defined as the blocking out-of-range code bit 1008 to indicate blocking of an out-of-range signal.

In an example, if one of the signals is an out-of-range signal, the UE can set the absolute CLI reported value 812 in the absolute CLI indicator field 810 in the L1 CLI report 800 shown in FIG. 8 to the blocking out-of-range code bit 908/1008 of the absolute CLI reported value 902/1002 associated with blocking (e.g., CLI-SRS-RSRP_98). In addition, the UE may set the first CLI resource index 806a in the first CLI resource index field of the L1 CLI report 800 shown in FIG. 8 to the CLI resource index of the CLI measurement resource on which the blocking signal was sent. In some examples, the UE may then set each of the remaining differential CLI reported values (e.g., 816a-816c) to respective unused code bits 910/1010 to indicate that no differential CLI can be reported (e.g., as it is difficult to calculate a differential based on an infinity value). The unused code bit 910/1010 may be defined in the tables 900/1000 to indicate an unused field (e.g., an unused differential CLI indicator field 814). For example, in the table 900 shown in FIG. 9, the absolute CLI reported value 902 with the code bit CLI-SRS-RSRP_99 may be defined as the unused code bit 910 to indicate an unused field in the L1 CLI report 800. In addition, in the table 1000 shown in FIG. 10, the Absolute CLI reported value 1002 with the code bit CLI-SRS-RSRP_78 may be defined as the unused code bit 1010 to indicate an unused field in the L1 CLI report 800. Thus, each of the remaining differential CLI reported values (e.g., 816a-816c) may be set to CLI-SRS-RSRP_99 910 or CLI-RSSI_78 1010. In this example, although the L1 CLI report 800 may include the CLI resource index 806a associated with the out-of-range signal, the L1 CLI report may not include the actual resource indexes of any other uplink reference signals since differential CLI reported values are not included for the other uplink reference signals. Thus, the remaining CLI resource indexes (e.g., 806b-806d) in the L1 CLI report may be set to respective dummy values.

In an example, if more than one of the signals is an out-of-range signal, the UE can set the absolute CLI reported value 812 in the absolute CLI indicator field 810 in the L1 CLI report 800 shown in FIG. 8 to the blocking out-of-range code bit 908/1008 of the absolute CLI reported value 902/1002 associated with blocking (e.g., CLI-SRS-RSRP_98). In addition, the UE can set one or more of the differential CLI reported values 816a-816c to the blocking out-of-range code bit 908/1008 based on the total number of out-of-range signals. For example, with two out-of-range signals, the UE may set the absolute CLI reported value 812 and the first differential CLI reported value 816a to the blocking out-of-range code bit 908/1008. Using the example again of two blocking signals, the UE may further set the first CLI resource index 806a in the first CLI resource index field and the second CLI resource index 806b in the second CLI resource index field of the L1 CLI report 800 shown in FIG. 8 to the respective CLI resource indexes of the CLI measurement resources on which the blocking signals were sent. In some examples, the UE may then set each of the remaining differential CLI reported values (e.g., 816c and 816c) to respective unused code bits 910/1010 and each of the remaining CLI resource indexes (e.g., 806c and 806d) in the L1 CLI report to respective dummy values.

Similarly, if the reporting criteria indicates the UE should report a set of least interfering CLI measurement resources, one or more of the signals (e.g., SRSs or other uplink/sidelink signals) may not be too weak due to a respective signal strength of the one or more signals being lower than a minimum absolute CLI level (e.g., the one or more signals may be weak signals). For example, the UE may attempt to measure the CLI caused by a first signal on a first CLI measurement resource, but either be unable to measure the CLI or measure a CLI that is lower than the minimum absolute CLI level (e.g., −140 dBm for CLI-SRS-RSRP or −100 dBm for CLI-RSSI), and therefore, out-of-range of the UE. To enable the UE to report the presence of one or more weak out-of-range signals, one of the CLI reported values (code bits) in each of table 900 and table 1000 may be defined to indicate a weak signal (e.g., one of the code bits may be a weak out-of-range code bit). For example, in table 900 shown in FIG. 9, the absolute CLI reported value 902 with the code bit CLI-SRS-RSRP_0 may be defined as the out-of-range code bit 912 to indicate a weak out-of-range signal. In addition, in table 1000 shown in FIG. 10, the Absolute CLI reported value 1002 with the code bit CLI-RSSI_00 may be defined as the out-of-range code bit 1012 to indicate a weak out-of-range signal. It should be noted that other existing or newly added code bits in the tables 900 and 1000 may be designated as the weak out-of-range code bit 912/1012 instead of CLI-SRS-RSRP_0 and CLI-RSSI_00.

In the example of one or more weak signals, the UE can set the absolute CLI reported value 812 in the absolute CLI indicator field 810 in the L1 CLI report 800 shown in FIG. 8 to the weak out-of-range code bit 912/1012 of the absolute CLI reported value 902/1002 associated with a weak signal (e.g., CLI-SRS-RSRP_0 or CLI-RSSI_00). In addition, the UE can set one or more of the differential CLI reported values 816a-816c to the weak out-of-range code bit 912/1012 based on the total number of out-of-range signals. For example, with two out-of-range signals, the UE may set the absolute CLI reported value 812 and the first differential CLI reported value 816a to the weak out-of-range code bit 912/1012. Using the example again of two weak signals, the UE may further set the first CLI resource index 806a in the first CLI resource index field and the second CLI resource index 806b in the second CLI resource index field of the L1 CLI report 800 shown in FIG. 8 to the respective CLI resource indexes of the CLI measurement resources on which the weak signals were sent. In some examples, the UE may then set each of the remaining differential CLI reported values (e.g., 816c and 816c) to respective unused code bits 910/1010 (e.g., since it is difficult to calculate a differential based on an infinity value) and each of the remaining CLI resource indexes (e.g., 806c and 806d) in the L1 CLI report to respective dummy values.

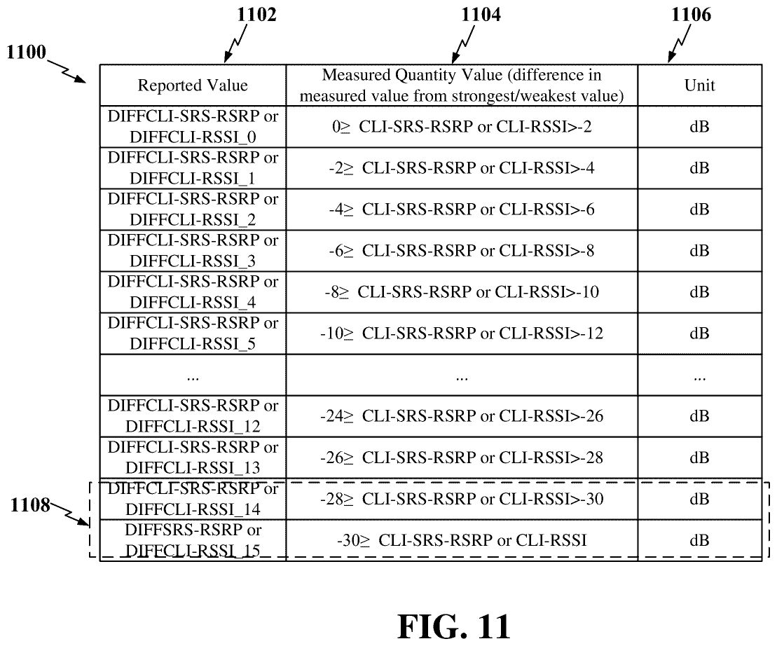

FIG. 11 is a diagram illustrating an example of a table of differential CLI reported values according to some aspects. The table 1100 shown in FIG. 11 includes a plurality of differential CLI reported values (Reported Value) 1102, a corresponding plurality of differential CLI levels (Measured Quantity Values (difference in measured value from strongest/weakest value)) 1104, and the respective units 1106 (e.g., dB) of each of the differential CLI levels 1104. The differential CLI levels 1104 are represented in the table 1100 with 2 dB resolution over a differential CLI reported value range. The differential CLI reported value range may be a differential CLI-SRS-RSRP range with each of the differential CLI reported values 1102 being a differential CLI-SRS-RSRP reported value having a respective code bit ranging from 0 to 15 or a differential CLI-RSSI range with each of the differential CLI reported values 1102 being a differential CLI-RSSI reported value having a respective code bit ranging from 0 to 15. Regardless of which differential CLI reported value range is applicable (CLI-SRS-RSRP or CLI-RSSI), each of the differential CLI levels 1104 (e.g., a differential CLI-SRS-RSRP or differential CLI-RSSI) is quantized to a 4-bit value in the range [0, −30] dB with 2 dB step size with reference to a highest measured (most interfering) L1 CLI-SRS-RSRP or L1-CLI-RSSI value or a lowest measured L1 CLI-SRS-RSRP or L1-CLI-RSSI value that is part of the same L1 CLI report instance. It should be noted that two separate differential tables 1100, one for differential CLI-SRS-RSRP and one for differential CLI-RSSI, may be defined and the selected differential table corresponds to the measurement type (RSRP or RSSI) used by the UE in measuring the CLI.

In examples in which there are no out-of-range signals (e.g., no blocking signals if the reporting criteria indicates the UE should report a set of most interfering CLI measurement resources or no weak signals if the reporting criteria indicates the UE should report a set of least interfering CLI measurement resources), the UE can set the absolute CLI reported value 812 in the absolute CLI indicator field 810 to the absolute CLI reported value 902/1002 associated with the highest (most interfering) or lowest (least interfering) measured CLI level 904/1004 in the L1 CLI report 800 shown in FIG. 8. The UE can further set the first CLI resource index 806a in the L1 CLI report 800 shown in FIG. 8 to the CLI resource index of the CLI measurement resource on which the highest/lowest measured CLI level 904/1004 was obtained. In addition, the UE can set the differential CLI reported values 816a-816c in the L1 CLI report 800 shown in FIG. 8 to the respective differential CLI reported values 1102 associated with each of the measured/calculated differential CLI levels 1104 of the remaining CLI measurement resources in the set of most/least interfering CLI measurement resources. The UE can further set the additional CSI resource indexes 806b-806d to the CLI resource indexes of the remaining CLI measurement resources.

In examples in which there are one or more out-of-range signals, instead of setting the remaining differential CLI reported values to unused code bits when one or more out-of-range code bits are reported indicating the presence of one or more blocking or weak signals, as described above, the UE can report the differential CLI reported values of the remaining CLI measurement resources as differential to a maximum absolute CLI level or a minimum absolute CLI level. For example, if the reporting criteria indicates that the UE should report the set of most interfering (highest CLI level) CLI measurement resources, the UE can use the CLI level of −44 dBm for CLI-SRS-RSRP measurements or the CLI level of −25 dB for CLI-RSSI measurements as the maximum absolute CLI level.

In this example, the UE can set the absolute CLI reported value 812 in the absolute CLI indicator field 810 in the L1 CLI report 800 shown in FIG. 8 to the blocking or weak out-of-range code bit 908/1008 or 912/1012 of the absolute CLI reported value 902/1002 associated with a blocking/weak signal (e.g., CLI-SRS-RSRP_98/CLI-SRS-RSRP_0 or CLI-RSSI_77/CLI-RSSI_00). In addition, the UE can set one or more of the differential CLI reported values 816a-816c to the blocking or weak out-of-range code bit 908/1008 or 912/1012 based on the total number of out-of-range signals. For example, with two out-of-range signals, the UE may set the absolute CLI reported value 812 and the first differential CLI reported value 816a to the blocking or weak out-of-range code bit 908/1008 or 912/1012. Using the example again of two out-of-range signals, the UE may further set the first CLI resource index 806a in the first CLI resource index field and the second CLI resource index 806b in the second CLI resource index field of the L1 CLI report 800 shown in FIG. 8 to the respective CLI resource indexes of the CLI measurement resources on which the blocking/weak signals were sent.

In addition, the UE can set the remaining differential CLI reported values (e.g., differential CLI reported values 816a-816c with only one blocking/weak signal or differential CLI reported values 816b and 816c with two blocking/weak signals) to differential CLI reported values 1102 indicative of a respective differential CLI level 1104 with respect to the maximum absolute CLI level corresponding to the maximum absolute CLI level (e.g., −44 dBm or −25 dB) or the minimum absolute CLI level corresponding to the minimum absolute CLI level (e.g., −140 dBm or −100 dB). Thus, in this example, the absolute CLI level corresponds to the highest/lowest absolute CLI level (maximum/minimum absolute CLI level) for purposes of calculating the differential CLI values. As an example, if the maximum absolute CLI level is used to calculate differential CLI values and the absolute CLI reported value is set to the blocking out-of-range code bit (for a single blocking signal), the differential CLI reported value 816a may be set to code bit 3 (e.g., DIFFCLI-SRS-RSRP_3 or DIFFCLI-RSSI_3) with a −6 dB differential CLI value with respect to −44 dBm or −25 dB. In addition, the differential CLI reported value 816b may be set to code bit 5 (e.g., DIFFCLI-SRS-RSRP_5 or DIFFCLI-RSSI_5) with a −10 dB differential CLI value with respect to −44 dBm or −25 dB. Furthermore, the differential CLI reported value 816a may be set to code bit 10 (e.g., DIFFCLI-SRS-RSRP_10 or DIFFCLI-RSSI_10) with a −20 dB differential CLI value with respect to −44 dBm or −25 dB.

In other examples in which there are one or more out-of-range signals, instead of reporting an out-of-range signal in the absolute CLI indicator field 810, the out-of-range signal(s) may be reported in the differential CLI indicator field(s) 814. For example, for a single out-of-range signal, the out-of-range signal may be reported within the differential CLI indicator field of a last differential CLI reported value 816c. The CLI resource index of the out-of-range signal may also be reported within the CLI resource index field 804 of a last CLI resource index 806d. For two out-of-range signals, the out-of-range signals may be reported within the differential CLI indicator fields of the last two differential CLI reported value 816b and 816c, and so on. The CLI resource indexes of the two out-of-range signals may also be reported within the CLI resource index fields 804 of the last two CLI resource indexes 806c and 806d.

To enable the UE to report the presence of one or more out-of-range signals, one of the differential CLI reported values (code bits) in the table 1100 may be defined to indicate an out-of-range signal (e.g., one of the code bits may be an out-of-range code bit 1108). For example, in table 1100 shown in FIG. 11, the differential CLI reported value 1102 with the code bit DIFFCLI-SRS-RSRP_14/DIFFCLI-RSSI_14 or DIFFCLI-SRS-RSRP_15/DIFFCLI-RSSI_15 may be defined as the out-of-range code bit 1108 to indicate an out-of-range signal. It should be noted that other existing code bits in the table 1100 may be designated as the out-of-range code bit 1108 instead of DIFFCLI-SRS-RSRP_14/DIFFCLI-RSSI_14 or DIFFCLI-SRS-RSRP_15/DIFFCLI-RSSI_15.

In this example, the absolute CLI indicator field 810 may include the absolute CLI reported value 812 of the highest (most interfering) or lowest (least interfering) measured in-range signal. Here, the in-range signal has a signal strength less than the maximum absolute CLI level or greater than the minimum absolute CLI level. Thus, the absolute CLI reported value 812 is set to the absolute CLI level 904/1004 associated with the highest (most interfering) or lowest (least interfering) measured in-range signal. In addition, the first CLI resource index field includes an in-range CLI resource index 806a associated with the absolute CLI reported value 812. Furthermore, remaining differential CLI reported values (e.g., differential CLI reported values 816a and 816b for in-range signals) are set to respective differential code bits indicative of respective differential CLI level with respect to the absolute CLI level. The remaining CLI resource indexes (e.g., CLI resource indexes 806b and 806c) are further set to the respective CLI resource indexes associated with the remaining differential CLI reported values 816a and 816b.

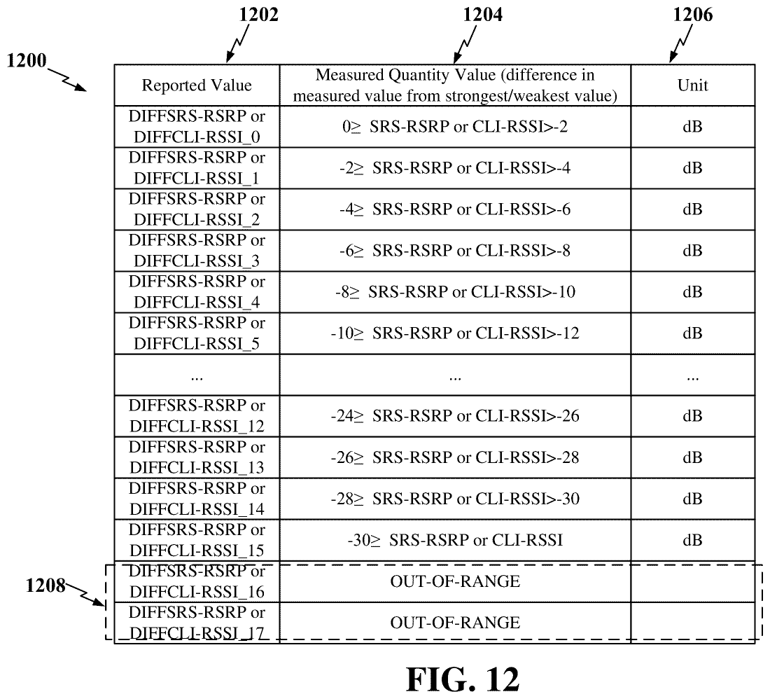

FIG. 12 is a diagram illustrating another example of a table of differential CLI reported values according to some aspects. The table 1200 shown in FIG. 12 includes a plurality of differential CLI reported values (Reported Value) 1202, a corresponding plurality of differential CLI levels (Measured Quantity Values (difference in measured value from strongest/weakest value)) 1204, and the respective units 1206 (e.g., dB) of each of the differential CLI levels 1204. The differential CLI levels 1204 are represented in the table 1200 with 2 dB resolution over a differential CLI reported value range. The table 1200 in FIG. 12 includes an expanded differential CLI reported value range to enable designation of one or more new code bits (differential CLI reported values 1202) as out-of-range code bits 1208.

For example, the differential CLI reported value range may be a differential CLI-SRS-RSRP range with each of the differential CLI reported values 1202 being a differential CLI-SRS-RSRP reported value having a respective code bit ranging from 0 to 17 or a differential CLI-RSSI range with each of the differential CLI reported values 1202 being a differential CLI-RSSI reported value having a respective code bit ranging from 0 to 17. Regardless of which differential CLI reported value range is applicable (CLI-SRS-RSRP or CLI-RSSI), each of the differential CLI levels 1204 (e.g., a differential CLI-SRS-RSRP or differential CLI-RSSI) is quantized to a 5-bit value (instead of a 4-bit value) still in the same CLI level range [0, −30] dB with 2 dB step size with reference to a highest measured (most interfering) L1 CLI-SRS-RSRP or L1-CLI-RSSI value or a lowest measured L1 CLI-SRS-RSRP or L1-CLI-RSSI value that is part of the same L1 CLI report instance. It should be noted that two separate differential tables 1200, one for differential CLI-SRS-RSRP and one for differential CLI-RSSI, may be defined and the selected differential table corresponds to the measurement type (RSRP or RSSI) used by the UE in measuring the CLI.

In examples in which one or more signals are out-of-range signals, the differential CLI reported values (e.g.., at least 816c) for each of the out-of-range signals may be set to code bit 16 (e.g., DIFFCLI-SRS-RSRP_16/DIFFCLI-RSSI_16) or code bit 17 (e.g., DIFFCLI-SRS-RSRP_17/DIFFCLI-RSSI_17) instead of code bit 14 or 15, as described with reference to FIG. 11. The CLI resource indexes, absolute CLI reported value and remaining CLI reported values may be set as described above in FIG. 11.

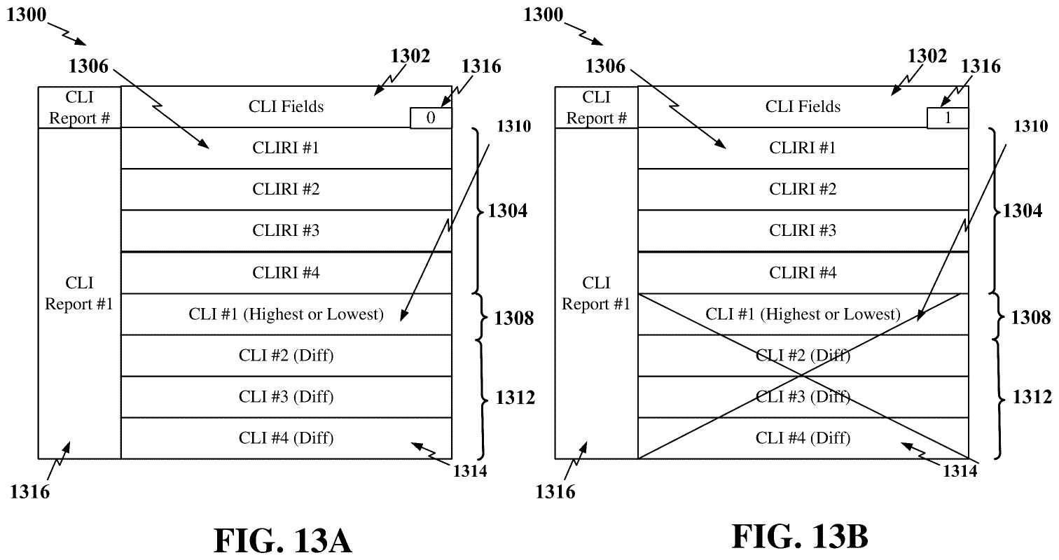

FIGS. 13A and 13B are diagrams illustrating examples of a L1 CLI report for out-of-range signals according to some aspects. The L1 CLI report 1300 shown in FIGS. 13A and 13B has a similar format to the L1 CLI report format illustrated in FIG. 8. For example, the format includes a plurality of CLI fields 1302 including, for example CLI resource index fields 1304 and CLI indicator fields 1308/1312. The CLI resource index fields 1304 may each be configured to include a respective one of a plurality of CLI resource indexes 1306 (e.g., CLIRI #1, CLIRI #2, CLIRI #3, and CLIRI #4), each identifying a different respective CLI measurement resource. The CLI indicator fields include an absolute CLI indicator field 1308 and differential CLI indicator fields 1312. The absolute CLI indicator field 1308 is configured to include an absolute CLI reported value 1310 (CLI #1) associated with a first CLI resource index 1306 (e.g., CLIRI #1). Each of the differential CLI indicator fields 1312 is configured to include a respective one of a plurality of differential CLI reported values 1314 (e.g., CLI #2 (Diff), CLI #3 (Diff), and CLI #4 (Diff)), each associated with a respective additional CLI resource index 1306 (e.g., CLIRI #2, CLIRI #3, and CLIRI #4). The L1 CLI report 1300 may further include an L1 CLI report number 1316 (CLI Report #1) indicating the number of the L1 CLI report in a series of L1 CLI reports. The absolute CLI reported value and the differential CLI reported values may be CLI-SRS-RSRP reported values or CLI-RSSI reported values. Thus, the L1 CLI report 1300 may be a L1 CLI-SRS-RSRP report or a L1 CLI-RSSI report.

In addition, in the L1 CLI report format shown in FIGS. 13A and 13B, the L1 CLI report 1300 further includes a bit 1316 indicating whether respective CLI resource indexes 1306 for one or more out-of-range signals are included in the L1 CLI report. Each of the one or more out-of-range signals has a signal strength outside of an absolute CLI level range (e.g., greater than a maximum absolute CLI level or less than a minimum absolute CLI level). The absolute CLI level range may be, for example, a CLI-SRS-RSRP range or a CLI-RSSI range.

In the example shown in FIG. 13A, the bit 1316 is set to zero, thus indicating that no out-of-range signals are included in the L1 CLI report 1300. In this example, the L1 CLI report includes the absolute CLI reported value 1310 indicating the absolute CLI level associated with the CLI measurement resource having the highest measured (or lowest measured) CLI level in the absolute CLI indicator field 1308, the CLI resource index 1306 identifying the CLI measurement resource having the highest/lowest CLI level in the first CLI resource index field 1304, the additional CLI resource indexes 1306 of additional CLI measurement resources having the next highest/lowest measured CLI levels in the additional CLI resource index fields 1304, and the differential CLI reported values 1314 (with respect to the absolute CLI level) associated with each of the additional CLI resource indexes 1306 in the differential CLI indicator fields 1312.

In the example shown in FIG. 13B, the bit 1316 is set to one, thus indicating that one or more out-of-range signals are included in the L1 CLI report 1300. In this example, the L1 CLI report includes the respective CLI resource indexes 1306 identifying each of the respective CLI measurement resources associated with each of the one or more out-of-range signals. However, any remaining CLI resource indexes 1306 are set to dummy values, and the L1 CLI report excludes the absolute CLI reported value 1310 and any differential CLI reported values 1314, thus reducing the payload of the L1 CLI report 1300 and saving overhead.

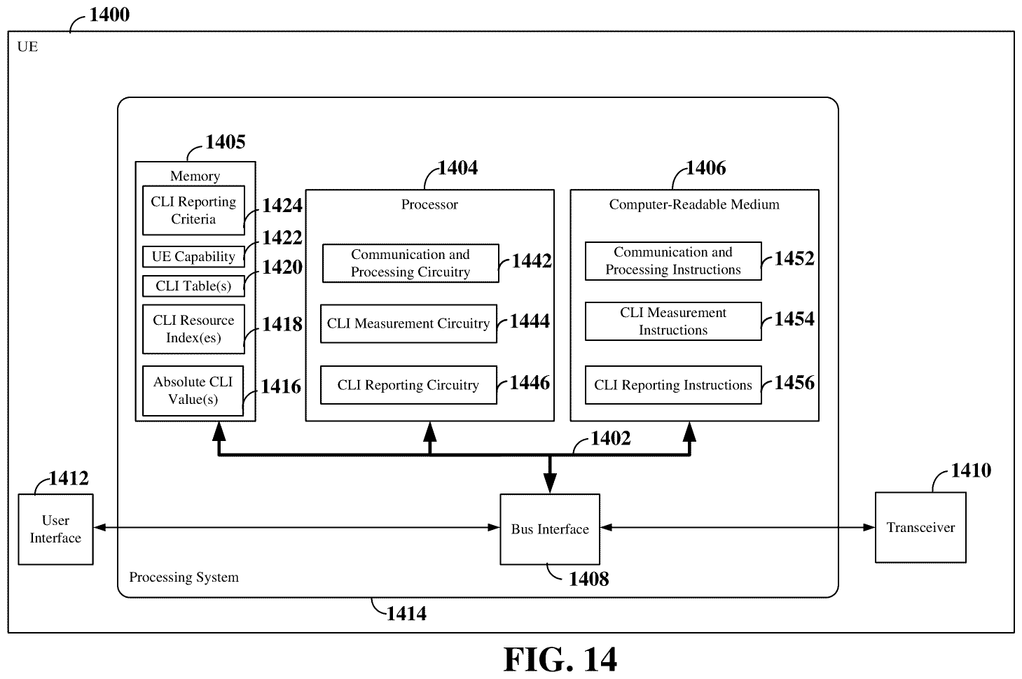

FIG. 14 is a block diagram illustrating an example of a hardware implementation for a user equipment (UE) employing a processing system 1414. For example, the UE 1400 may correspond to any of the UEs shown and described above in reference to FIGS. 1, 2 and/or 5-7.

The UE 1400 may be implemented with a processing system 1414 that includes one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in the UE 1400, may be used to implement any one or more of the processes and procedures described below.

The processor 1404 may in some instances be implemented via a baseband or modem chip and in other implementations, the processor 1404 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 links together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402 and at least one transceiver 1410. The transceiver 1410 provides a means for communicating with various other apparatus over a transmission medium (e.g., air interface).

The processor 1404 is responsible for managing the bus 1402 and general processing, including the execution of software stored on the computer-readable medium 1406. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1404, causes the processing system 1414 to perform the various functions described below for any particular apparatus. The computer-readable medium 1406 and the memory 1405 may also be used for storing data that is utilized by the processor 1404 when executing software. For example, the memory 1405 may store one or more of absolute CLI value(s) 1416, such as measured absolute CLI level(s), CLI resource index(es) 1418 associated with the measured CLI value(s) 1416, one or more tables 1420, such as any of the tables shown in FIGS. 9-12, a UE capability 1422, and CLI reporting criteria 1424 that may be utilized by the processor 1404 when executing software.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. In some examples, the computer-readable medium 1406 may be part of the memory 1405. Those skilled in the art will recognize how best to implement the described functionality presented throughout this disclosure depending on the particular application and the overall design constraints imposed on the overall system.

In some aspects of the disclosure, the processor 1404 may include circuitry configured for various functions. For example, the processor 1404 may include communication and processing circuitry 1442, configured to communicate with a network entity (e.g., an aggregated or disaggregated base station, such as a gNB or eNB). In some examples, the communication and processing circuitry 1442 may include one or more hardware components that provide the physical structure that performs processes related to wireless communication (e.g., signal reception and/or signal transmission) and signal processing (e.g., processing a received signal and/or processing a signal for transmission). In some examples, the communication and processing circuitry 1442 may include low complexity circuitry for baseband or near-baseband processing with minimal RF processing.

In some implementations where the communication involves receiving information, the communication and processing circuitry 1442 may receive a signal from a component of the UE 1400 (e.g., from the transceiver 1410 that receives the information via radio frequency signaling or some other type of signaling suitable for the applicable communication medium), process (e.g., decode) the information, and output the processed information. For example, the communication and processing circuitry 1442 may output the information to another component of the processor 1404, to the memory 1405, or to the bus interface 1408. In some examples, the communication and processing circuitry 1442 may receive one or more of signals, messages, other information, or any combination thereof. In some examples, the communication and processing circuitry 1442 may receive information via one or more channels. In some examples, the communication and processing circuitry 1442 may include functionality for a means for receiving. In some examples, the communication and processing circuitry 1442 may include functionality for a means for processing, including a means for demodulating, a means for decoding, etc.

In some implementations where the communication involves sending (e.g., transmitting) information, the communication and processing circuitry 1442 may obtain information (e.g., from another component of the processor 1404, the memory 1405, or the bus interface 1408), process (e.g., modulate, encode, etc.) the information, and output the processed information. For example, the communication and processing circuitry 1442 may output the information to the transceiver 1410 (e.g., that transmits the information via radio frequency signaling or some other type of signaling suitable for the applicable communication medium). In some examples, the communication and processing circuitry 1442 may send one or more of signals, messages, other information, or any combination thereof. In some examples, the communication and processing circuitry 1442 may send information via one or more channels. In some examples, the communication and processing circuitry 1442 may include functionality for a means for sending (e.g., a means for transmitting). In some examples, the communication and processing circuitry 1442 may include functionality for a means for generating, including a means for modulating, a means for encoding, etc.

In some examples, the communication and processing circuitry 1442 may be configured to transmit via the transceiver 1410 a L1 CLI report to a network entity. The communication and processing circuitry 1442 may further be configured to transmit via the transceiver 1410 the UE capability 1422 of the UE 1400 to the network entity. The UE capability 1422 may indicate a maximum number of CLI reported values supported by the UE. The communication and processing circuitry 1442 may further be configured to receive via the transceiver 1410 the reporting criteria 1424 from the network entity and to store the reporting criteria, for example, within the memory 1405. The reporting criteria 1424 may include, for example, a total number of CLI reported values including an absolute CLI reported value and a plurality of differential CLI reported values to include in the L1 CLI report. In some examples, the total number of CLI reported values may be configured by the network entity based on the capability of the UE (UE capability 1422). In some examples, the reporting criteria 1424 requests reporting of a set of most interfering CLI measurement resources or a set of least interfering CLI measurement resources. The communication and processing circuitry 1442 may further be configured to execute communication and processing instructions (software) 1452 stored in the computer-readable medium 1406 to implement one or more of the functions described herein.

The processor 1404 may further include CLI measurement circuitry 1444, configured to measure cross-link interference (CLI) caused by transmission of at least one signal sent from at least one additional UE on at least one CLI measurement resource in a full-duplex or sub-band full-duplex mode. For example, the CLI measurement circuitry 1444 may be configured to measure a CLI sounding reference signal (SRS)-reference signal received power (RSRP) or a CLI-received signal strength indicator (RSSI) on each of the at least one CLI measurement resources. The measured CLI values may be absolute CLI values (absolute CLI levels) 1416 that may be stored, for example, in memory 1405. The CLI measurement circuitry 1444 may further be configured to execute CLI measurement instructions (software) 1454 stored in the computer-readable medium 1406 to implement one or more of the functions described herein.

The processor 1404 may further include CLI reporting circuitry 1446, configured to generate and transmit the L1 CLI report to the network entity via the communication and processing circuitry 1442 and transceiver 1410. The L1 CLI report may include a plurality of CLI resource index fields, each configured to include a respective one of a plurality of CLI resource indexes 1418, each identifying a different respective CLI measurement resource of the at least one CLI measurement resource, an absolute CLI indicator field configured to include an absolute CLI reported value associated with a first CLI resource index field of the plurality of CLI resource index fields, where the absolute CLI reported value is indicative of an absolute CLI level 1416 based on the reporting criteria 1424, and a plurality of differential CLI indicator fields associated with additional CLI resource indexes 1418 of the plurality of CLI resource indexes, each configured to include a respective one of a plurality of differential CLI reported values, where each of the plurality of differential CLI reported values is indicative of a differential CLI level with respect to the absolute CLI level 1416.

In some examples, the L1 CLI report includes a first CLI resource index within the first CLI resource index field, the absolute CLI reported value associated with the first CLI resource index in the absolute CLI indicator field, the additional CLI resource indexes in remaining CLI resource index fields of the plurality of CLI resource index fields, and the plurality of differential CLI reported values in the plurality of differential CLI indicator fields. For example, the CLI reporting circuitry 1446 may be configured to identify a highest (or lowest) absolute CLI level 1416 measured by the CLI measurement circuitry 1444 (e.g., based on the reporting criteria 1424) and include the absolute CLI reported value associated with the highest (or lowest) absolute CLI level 1416 within the absolute CLI indicator field. The CLI reporting circuitry 1446 may further calculate the respective differential CLI levels for each of the next highest (or next lowest) absolute CLI levels 1416. For example, the CLI reporting circuitry 1446 may calculate the difference between the highest absolute CLI level 1416 and the next highest absolute CLI level 1416 as a first differential CLI level, and continue this process in order of highest absolute CLI levels up to the total number of CLI reported values to be included in the L1 CLI report. The CLI reporting circuitry 1446 can then set the plurality of differential CLI indicator fields to the plurality of differential CLI reported values associated with each of the calculated differential CLI levels. In addition, the CLI reporting circuitry 1446 can include the respective CLI resource indexes 1418 associated with the absolute CLI reported value and each of the plurality of differential CLI reported values in respective CLI resource index fields of the L1 CLI report. For example, the CLI resource index 1418 (e.g., the first CLI resource index) associated with the absolute CLI reported value may be included within a first CLI resource index field and the additional CLI resource indexes 1418 may be included within subsequent CLI resource index fields in order of differential CLI reported values. Note that the differential CLI reported values are also ordered in the L1 CLI report (from lowest differential CLI level to highest differential CLI level).

In some examples, the absolute CLI reported value is a CLI sounding reference signal (SRS)-reference signal received power (RSRP) reported value and the differential CLI reported values are differential CLI SRS-RSRP reported values. In some examples, the absolute CLI reported value is a CLI-received signal strength indicator (RSSI) reported value and the differential CLI reported values are differential CLI-RSSI reported values. In some examples, the absolute CLI level is selected from a table 1420 of absolute CLI reported values and corresponding absolute CLI levels with 1 dB resolution. In some examples, the differential CLI levels are selected from a table 1420 of differential CLI reported values, each representing a range with 2 dB resolution of differential CLI levels with respect to the absolute CLI level.

In some examples, a least a first reference signal of the at least one signal sent on a first CLI measurement resource of the at least one CLI measurement resource is an out-of-range signal having a signal strength outside of an absolute CLI level range (e.g., higher than a maximum absolute CLI level or lower than a minimum absolute CLI level). In this example, the CLI reporting circuitry 1446 may be configured to generate and transmit the L1 CLI report including at least a first CLI resource index identifying at least the first CLI measurement resource and at least a first CLI reported value associated with at least the first CLI resource index set to an out-of-range code bit. In some examples, the out-of-range code bit may be selected from a table 1420 of absolute CLI reported values. For example, the out-of-range code bit may be associated with a new absolute CLI reported value (e.g., a new code bit) in the table 1420 or may be associated with an existing absolute CLI reported value (e.g., an existing code bit) in the table 1420 configured to indicate an out-of-range CLI level. For example, if the signal strength is lower than the minimum absolute CLI level in the absolute CLI level range, the out-of-range code bit may be associated with a lowest absolute CLI reported value in the table 1420.

In some examples, the CLI reporting circuitry 1446 may further be configured to generate and transmit the L1 CLI report including the first CLI resource index field including the first CLI resource index, the absolute CLI indicator field including the first CLI reported value, each remaining CLI resource index of the additional CLI resource indexes set to a respective dummy value, and each remaining differential CLI reported value of the plurality of differential CLI reported values set to a respective unused code bit. In some examples, the CLI reporting circuitry 1446 may further be configured to generate and transmit the L1 CLI report including at least a second CLI resource index identifying at least a second CLI measurement resource having a second out-of-range signal associated therewith, and at least a first differential CLI reported value associated with at least the second CLI resource index set to the out-of-range code bit. In some examples, the unused code bit may further be selected from the table 1420 of absolute CLI reported values. For example, the unused code bit may be associated with a new absolute CLI reported value (e.g., a new code bit) in the table 1420.

In other examples, the CLI reporting circuitry 1446 may be configured to generate and transmit the L1 CLI report including the first CLI resource index field including the first CLI resource index, the absolute CLI indicator field including the first CLI reported value, each remaining CLI resource index of the additional CLI resource indexes set to a respective CLI resource index, and each remaining differential CLI reported value of the plurality of differential CLI reported values set to a respective differential code bit indicative of a respective differential CLI level with respect to a maximum absolute CLI level or a minimum absolute CLI level in the absolute CLI level range. Here, the absolute CLI level corresponds to the maximum absolute CLI level or the minimum absolute CLI level. For example, the absolute CLI level range may correspond to a CLI-SRS-RSRP range or a CLI-RSSI range.

In still other examples, the CLI reporting circuitry 1446 may be configured to generate and transmit the L1 CLI report including the absolute CLI indicator field set to the absolute CLI level associated with an in-range signal of the at least one signal that is within the absolute CLI level range, the first CLI resource index field including an in-range CLI resource index (i.e., a CLI resource index corresponding to a CLI resource on which an in-range signal was received) associated with the absolute CLI reported value, at least a last CLI resource index field of the plurality of CLI resource index fields including at least the first CLI resource index, at least a last differential CLI indicator field of the plurality of differential CLI indicator fields including at least the first CLI reported value set to the out-of-range code bit, and remaining differential CLI reported values of the plurality of differential CLI reported values set to respective differential code bits indicative of respective differential CLI level with respect to the absolute CLI level. In this example, the out-of-range code bit is selected from a table 1420 of differential CLI reported values, each representing a range with 2 dB resolution of differential CLI levels with respect to the absolute CLI level. For example, the out-of-range code bit may be associated with an existing differential CLI reported value (e.g., an existing code bit) in the table 1420, and as such, each differential CLI reported value may be four bits (e.g., each code bit may include four bits). As another example, the out-of-range code bit may be associated with a new differential CLI reported value (e.g., a new code bit) in the table 1420 configured to indicate an out-of-range CLI level, and as such, each differential CLI reported value may be five bits (e.g., each code bit may include five bits) to accommodate the new differential CLI reported value.

In some examples, the CLI reporting circuitry 1446 may be configured to generate and transmit the L1 CLI report including a bit indicating whether respective CLI resource indexes for one or more out-of-range signals are included in the L1 CLI report, where each of the one or more out-of-range signals has a signal strength outside of an absolute CLI level range. For example, the one or more out-of-range signals may include at least a first out-of-range signal associated with at least a first CLI measurement resource. In this example, the CLI reporting circuitry 1446 may be configured to generate and transmit the L1 CLI report including at least the first CLI resource index field including at least a first CLI resource index identifying the first CLI measurement resource, each remaining CLI resource index of the additional CLI resource indexes set to a respective dummy value, and excluding the absolute CLI reported value and each of the plurality of differential CLI reported values. The CLI reporting circuitry 1446 may further be configured to execute CLI reporting instructions (software) 1456 stored in the computer-readable medium 1406 to implement one or more of the functions described herein.

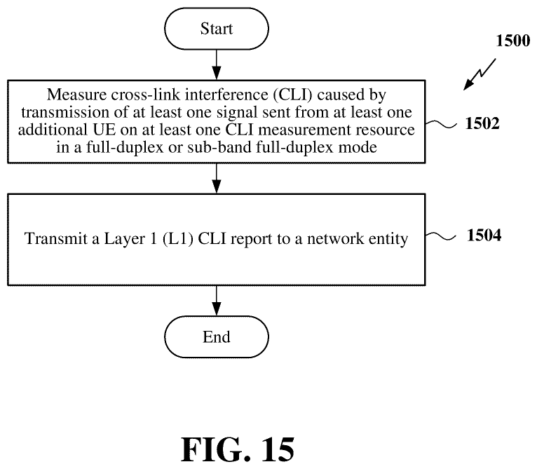

FIG. 15 is a flow chart of an exemplary process 1500 for cross-link interference reporting according to some aspects. As described below, some or all illustrated features may be omitted in a particular implementation within the scope of the present disclosure, and some illustrated features may not be required for implementation of all examples. In some examples, the process 1500 may be performed by the UE 1400, as described above and illustrated in FIG. 14, by a processor or processing system, or by any suitable means for carrying out the described functions.

At block 1502, the UE may measure cross-link interference (CLI) caused by transmission of at least one signal sent from at least one additional UE on at least one CLI measurement resource in a full-duplex or sub-band full-duplex mode. For example, the CLI measurement circuitry 1444 shown and described above in connection with FIG. 14 may provide a means to measure the CLI.

At block 1504, the UE may transmit a Layer 1 (L1) CLI report to a network entity. The L1 CLI report may include an absolute CLI indicator field configured to include an absolute CLI reported value associated with a first CLI resource index field identifying one of the at least one CLI measurement resource, where the absolute CLI reported value is indicative of an absolute CLI level based on a reporting criteria. In addition, the L1 CLI report may include, responsive to the at least one CLI measurement resource including a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level. For example, the CLI reporting circuitry 1446, communication and processing circuitry 1442, and transceiver 1410, shown and described above in connection with FIG. 14, may provide a means to transmit the L1 CLI report.

In some examples, the absolute CLI reported value is a CLI sounding reference signal (SRS)-reference signal received power (RSRP) reported value and the differential CLI reported values are differential CLI SRS-RSRP reported values. In some examples, the absolute CLI reported value is a CLI-received signal strength indicator (RSSI) reported value and the differential CLI reported values are differential CLI-RSSI reported values. In some examples, the reporting criteria requests reporting of a set of most interfering CLI measurement resources or a set of least interfering CLI measurement resources. In some examples, the reporting criteria indicates a total number of CLI reported values including the absolute CLI reported value and the at least one differential CLI reported value configured by the network entity based on a capability of the UE. In some examples, the UE may further transmit to the network entity the capability of the UE indicating a maximum number of CLI reported values supported by the UE.

In some examples, the L1 CLI report includes at least one CLI resource index field including the first CLI resource index field and the at least one additional CLI resource index field. Each of the at least one CLI resource index field is configured to include a respective one of at least one CLI resource index, and each of the at least one CLI resource index identifying a different respective CLI measurement resource of the at least one CLI measurement resource. In some examples, the UE may transmit the L1 CLI report including a first CLI resource index within the first CLI resource index field, the absolute CLI reported value associated with the first CLI resource index in the absolute CLI indicator field, at least one additional CLI resource index in the at least one additional CLI resource index field, and the at least one differential CLI reported value in the at least one differential CLI indicator field. In some examples, the at least one differential CLI reported value includes a plurality of differential CLI reported values.

In some examples, at least a first reference signal of the at least one signal sent on a first CLI measurement resource of the at least one CLI measurement resource is an out-of-range signal having a signal strength outside of an absolute CLI level range. In this example, the UE may further transmit the L1 CLI report including at least a first CLI resource index identifying at least the first CLI measurement resource and at least a first CLI reported value associated with at least the first CLI resource index set to an out-of-range code bit. In some examples, the absolute CLI level range corresponds to a CLI-SRS-RSRP range or a CLI-RSSI range. In some examples, each of the at least one differential CLI reported value is set to a respective differential code bit indicative of a respective differential CLI level with respect to a maximum absolute CLI level or a minimum absolute CLI level in the absolute CLI level range, where the absolute CLI level corresponds to the maximum absolute CLI level or the minimum absolute CLI level.

In some examples, the L1 CLI report may include the first CLI resource index field including the first CLI resource index, the absolute CLI indicator field including the first CLI reported value, each of the at least one additional CLI resource index is set to a respective dummy value, and each of the at least one differential CLI reported value is set to a respective unused code bit. In some examples, the L1 CLI report may further include at least a second CLI resource index identifying at least a second CLI measurement resource having a second out-of-range signal associated therewith, and at least a first differential CLI reported value associated with at least the second CLI resource index set to the out-of-range code bit. In some examples, the out-of-range code bit and the unused code bit are selected from a table of absolute CLI reported values and corresponding absolute CLI levels with 1 dB resolution. In some examples, the signal strength is lower than a minimum absolute CLI level in the absolute CLI level range, and the out-of-range code bit is associated with a lowest absolute CLI reported value in the table.

In some examples, the L1 CLI report includes the absolute CLI indicator field set to the absolute CLI level associated with an in-range signal of the at least one signal that is within the absolute CLI level range, the first CLI resource index field including an in-range CLI resource index associated with the absolute CLI reported value, at least a last CLI resource index field of the at least one CLI resource index field including at least the first CLI resource index, at least a last differential CLI indicator field of the at least one differential CLI indicator field including at least the first CLI reported value set to the out-of-range code bit, and additional differential CLI reported values of the at least one differential CLI reported value set to respective differential code bits indicative of respective differential CLI level with respect to the absolute CLI level. In some examples, the out-of-range code bit is selected from a table of differential CLI reported values, each representing a range with 2 dB resolution of differential CLI levels with respect to the absolute CLI level and each having four bits. In other examples, the out-of-range code bit is selected from a table of differential CLI reported values, each representing a range with 2 dB resolution of differential CLI levels with respect to the absolute CLI level and each having five bits.

In some examples, the L1 CLI report may include a bit indicating whether respective CLI resource indexes for one or more out-of-range signals are included in the L1 CLI report, each of the one or more out-of-range signals having a signal strength outside of an absolute CLI level range. In an example, the one or more out-of-range signals includes at least a first out-of-range signal associated with at least a first CLI measurement resource. In this example, the L1 CLI report may include at least the first CLI resource index field including at least a first CLI resource index identifying the first CLI measurement resource, each of the at least one additional CLI resource index is set to a respective dummy value, and excluding the absolute CLI reported value and the at least one differential CLI reported value.

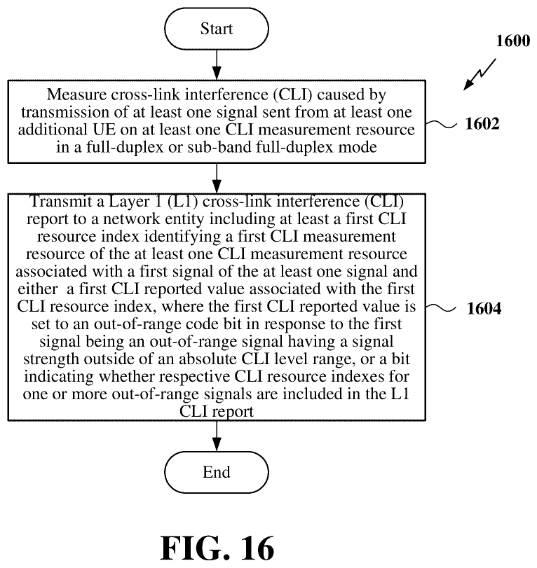

FIG. 16 is a flow chart of another exemplary process 1600 for exemplary process for cross-link interference reporting according to some aspects. As described below, some or all illustrated features may be omitted in a particular implementation within the scope of the present disclosure, and some illustrated features may not be required for implementation of all examples. In some examples, the process 1600 may be performed by the UE 1400, as described above and illustrated in FIG. 14, by a processor or processing system, or by any suitable means for carrying out the described functions.

At block 1602, the UE may measure cross-link interference (CLI) caused by transmission of at least one signal sent from at least one additional UE on at least one CLI measurement resource in a full-duplex or sub-band full-duplex mode. For example, the CLI measurement circuitry 1444 shown and described above in connection with FIG. 14 may provide a means to measure the CLI.

At block 1604, the UE may transmit a Layer 1 (L1) CLI report to a network entity. The L1 CLI report may include at least a first CLI resource index identifying a first CLI measurement resource of the at least one CLI measurement resource associated with a first signal of the at least one signal and either a first CLI reported value associated with the first CLI resource index, where the first CLI reported value is set to an out-of-range code bit in response to the first signal being an out-of-range signal having a signal strength outside of an absolute CLI level range, or a bit indicating whether respective CLI resource indexes for one or more out-of-range signals are included in the L1 CLI report. For example, the CLI reporting circuitry 1446, communication and processing circuitry 1442, and transceiver 1410, shown and described above in connection with FIG. 14, may provide a means to transmit the L1 CLI report.

In one configuration, the UE 1400 includes means for measuring cross-link interference (CLI) caused by transmission of at least one signal sent from at least one additional UE on at least one CLI measurement resource in a full-duplex or sub-band full-duplex mode and means for transmitting a layer 1 (L1) CLI report to a network entity including a plurality of CLI resource index fields, each configured to include a respective one of a plurality of CLI resource indexes, each identifying a different respective CLI measurement resource of the at least one CLI measurement resource, an absolute CLI indicator field configured to include an absolute CLI reported value associated with a first CLI resource index field of the plurality of CLI resource index fields, where the absolute CLI reported value is indicative of an absolute CLI level based on a reporting criteria, and a plurality of differential CLI indicator fields associated with additional CLI resource indexes of the plurality of CLI resource indexes, each configured to include a respective one of a plurality of differential CLI reported values, where each of the plurality of differential CLI reported values is indicative of a differential CLI level with respect to the absolute CLI level, as described in the present disclosure. In one aspect, the aforementioned means may be the processor 1404 shown in FIG. 14 configured to perform the functions recited by the aforementioned means. In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable storage medium 1406, or any other suitable apparatus or means described in any one of the FIGS. 1, 2, and/or 5-7 utilizing, for example, the processes and/or algorithms described herein in relation to FIGS. 15 and 16.

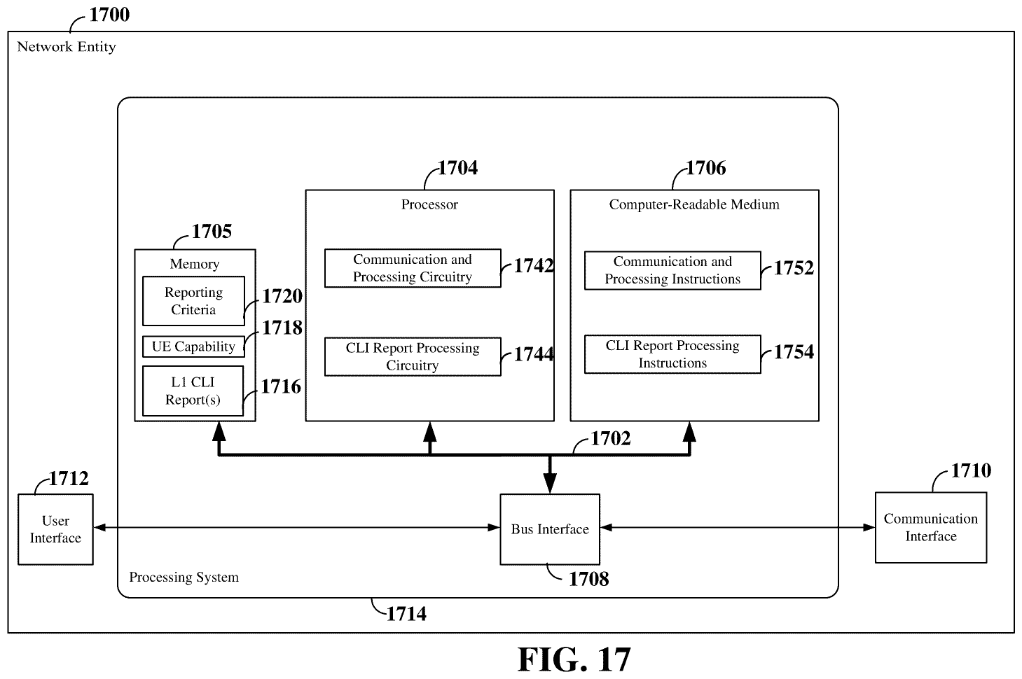

FIG. 17 is a block diagram illustrating an example of a hardware implementation for an exemplary network entity 1700 employing a processing system 1714. For example, the network entity 1700 may correspond to any of the network entities (e.g., aggregated or disaggregated base stations) shown in any one or more of FIGS. 1, 2, and/or 5-7.

In accordance with various aspects of the disclosure, an element, or any portion of an element, or any combination of elements may be implemented with a processing system 1714 that includes one or more processors 1704. The processing system 1714 may be substantially the same as the processing system 1514 illustrated in FIG. 15, including a bus interface 1708, a bus 1702, memory 1705, a processor 1704, and a computer-readable medium 1706. Furthermore, the network entity 1700 may include an optional user interface 1712 and a communication interface (e.g., a transceiver and one or more antenna arrays or a network interface). The processor 1704, as utilized in a network entity 1700, may be used to implement any one or more of the processes described herein. In some examples, the memory 1705 may store one or more of L1 CLI report(s) 1716, UE capability 1718, and/or CLI reporting criteria 1720 that may be utilized by the processor 1704 when executing software.

The processor 1704 may include communication and processing circuitry 1742 configured to communicate with one or more UEs or other network entities. In some examples, the communication and processing circuitry 1742 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1742 may include one or more transmit/receive chains.

In some implementations where the communication involves receiving information, the communication and processing circuitry 1742 may obtain information from a component of the network entity 1700 (e.g., from the communication interface 1710 that receives the information via radio frequency signaling or some other type of signaling suitable for the applicable communication medium), process (e.g., decode) the information, and output the processed information. For example, the communication and processing circuitry 1742 may output the information to another component of the processor 1704, to the memory 1705, or to the bus interface 1708. In some examples, the communication and processing circuitry 1742 may receive one or more of signals, messages, other information, or any combination thereof. In some examples, the communication and processing circuitry 1742 may receive information via one or more channels. In some examples, the communication and processing circuitry 1742 may include functionality for a means for receiving. In some examples, the communication and processing circuitry 1742 may include functionality for a means for processing, including a means for demodulating, a means for decoding, etc.

In some implementations where the communication involves sending (e.g., transmitting) information, the communication and processing circuitry 1742 may obtain information (e.g., from another component of the processor 1704, the memory 1705, or the bus interface 1708), process (e.g., modulate, encode, etc.) the information, and output the processed information. For example, the communication and processing circuitry 1742 may output the information to the communication interface 1710 (e.g., that transmits the information via radio frequency signaling or some other type of signaling suitable for the applicable communication medium). In some examples, the communication and processing circuitry 1742 may send one or more of signals, messages, other information, or any combination thereof. In some examples, the communication and processing circuitry 1742 may send information via one or more channels. In some examples, the communication and processing circuitry 1742 may include functionality for a means for sending (e.g., a means for transmitting). In some examples, the communication and processing circuitry 1742 may include functionality for a means for generating, including a means for modulating, a means for encoding, etc.

The communication and processing circuitry 1742 may be configured to obtain via the communication interface 1710 at least one signal sent from at least at least one user equipment (UE) on at least one cross-link interference (CLI) measurement resource in a full-duplex or sub-band full-duplex mode. The communication and processing circuitry 1742 may further be configured to obtain via the communication interface 1710 an L1 CLI report 1716 from a first UE. The communication and processing circuitry 1742 may further store the received L1 CLI report 1716 within, for example, memory 1705. The communication and processing circuitry 1742 may further be configured to obtain via the communication interface 1710 the UE capability 1718 of the first UE. The UE capability 1718 may indicate a maximum number of CLI reported values supported by the UE. The communication and processing circuitry 1742 may further be configured to provide via the communication interface 1710 the reporting criteria 1720 to the first UE. The reporting criteria 1720 may include, for example, a total number of CLI reported values including an absolute CLI reported value and a plurality of differential CLI reported values to include in the L1 CLI report. In some examples, the total number of CLI reported values may be configured by the network entity 1700 based on the capability of the UE (UE capability 1718). In some examples, the reporting criteria 1720 requests reporting of a set of most interfering CLI measurement resources or a set of least interfering CLI measurement resources. The communication and processing circuitry 1742 may further be configured to execute communication and processing instructions (software) 1752 stored in the computer-readable medium 1706 to implement one or more of the functions described herein.

The processor 1704 may further include CLI report processing circuitry 1744, configured to process the L1 CLI report 1716 received from the first UE. The L1 CLI report 1716 may include a plurality of CLI resource index fields, each configured to include a respective one of a plurality of CLI resource indexes, each identifying a different respective CLI measurement resource of the at least one CLI measurement resource, an absolute CLI indicator field configured to include an absolute CLI reported value associated with a first CLI resource index field of the plurality of CLI resource index fields, where the absolute CLI reported value is indicative of an absolute CLI level based on the reporting criteria 1720, and a plurality of differential CLI indicator fields associated with additional CLI resource indexes of the plurality of CLI resource indexes, each configured to include a respective one of a plurality of differential CLI reported values, where each of the plurality of differential CLI reported values is indicative of a differential CLI level with respect to the absolute CLI level.

In some examples, the L1 CLI report includes a first CLI resource index within the first CLI resource index field, the absolute CLI reported value associated with the first CLI resource index in the absolute CLI indicator field, the additional CLI resource indexes in remaining CLI resource index fields of the plurality of CLI resource index fields, and the plurality of differential CLI reported values in the plurality of differential CLI indicator fields. In some examples, the absolute CLI reported value is a CLI sounding reference signal (SRS)-reference signal received power (RSRP) reported value and the differential CLI reported values are differential CLI SRS-RSRP reported values. In some examples, the absolute CLI reported value is a CLI-received signal strength indicator (RSSI) reported value and the differential CLI reported values are differential CLI-RSSI reported values.

In some examples, a least a first reference signal of the at least one signal sent on a first CLI measurement resource of the at least one CLI measurement resource is an out-of-range signal having a signal strength outside of an absolute CLI level range (e.g., higher than a maximum absolute CLI level or lower than a minimum absolute CLI level). In this example, the L1 CLI report may include at least a first CLI resource index identifying at least the first CLI measurement resource and at least a first CLI reported value associated with at least the first CLI resource index set to an out-of-range code bit.

In some examples, the L1 CLI report may include the first CLI resource index field including the first CLI resource index, the absolute CLI indicator field including the first CLI reported value, each remaining CLI resource index of the additional CLI resource indexes set to a respective dummy value, and each remaining differential CLI reported value of the plurality of differential CLI reported values set to a respective unused code bit. In some examples, the L1 CLI report may further include at least a second CLI resource index identifying at least a second CLI measurement resource having a second out-of-range signal associated therewith, and at least a first differential CLI reported value associated with at least the second CLI resource index set to the out-of-range code bit.

In other examples, the L1 CLI report may include the first CLI resource index field including the first CLI resource index, the absolute CLI indicator field including the first CLI reported value, each remaining CLI resource index of the additional CLI resource indexes set to a respective CLI resource index, and each remaining differential CLI reported value of the plurality of differential CLI reported values set to a respective differential code bit indicative of a respective differential CLI level with respect to a maximum absolute CLI level or a minimum absolute CLI level in the absolute CLI level range. Here, the absolute CLI level corresponds to the maximum absolute CLI level or the minimum absolute CLI level. For example, the absolute CLI level range may correspond to a CLI-SRS-RSRP range or a CLI-RSSI range.

In still other examples, the L1 CLI report may include the absolute CLI indicator field set to the absolute CLI level associated with an in-range signal of the at least one signal that is within the absolute CLI level range, the first CLI resource index field including an in-range CLI resource index associated with the absolute CLI reported value, at least a last CLI resource index field of the plurality of CLI resource index fields including at least the first CLI resource index, at least a last differential CLI indicator field of the plurality of differential CLI indicator fields including at least the first CLI reported value set to the out-of-range code bit, and remaining differential CLI reported values of the plurality of differential CLI reported values set to respective differential code bits indicative of respective differential CLI level with respect to the absolute CLI level.

In some examples, the L1 CLI report may include a bit indicating whether respective CLI resource indexes for one or more out-of-range signals are included in the L1 CLI report, where each of the one or more out-of-range signals has a signal strength outside of an absolute CLI level range. For example, the one or more out-of-range signals may include at least a first out-of-range signal associated with at least a first CLI measurement resource. In this example, the L1 CLI report may include at least the first CLI resource index field including at least a first CLI resource index identifying the first CLI measurement resource, each remaining CLI resource index of the additional CLI resource indexes set to a respective dummy value, and excluding the absolute CLI reported value and each of the plurality of differential CLI reported values. The CLI report processing circuitry 1744 may further be configured to execute CLI report processing instructions (software) 1754 stored in the computer-readable medium 1706 to implement one or more of the functions described herein.

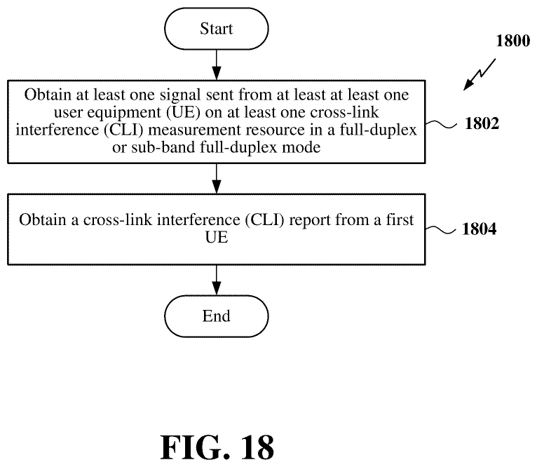

FIG. 18 is a flow chart of another exemplary process 1800 for cross-link interference reporting according to some aspects. As described below, some or all illustrated features may be omitted in a particular implementation within the scope of the present disclosure, and some illustrated features may not be required for implementation of all examples. In some examples, the process 1800 may be performed by the network entity 1700, as described above and illustrated in FIG. 17, by a processor or processing system, or by any suitable means for carrying out the described functions.

At block 1802, the network entity may obtain at least one signal sent from at least at least one user equipment (UE) on at least one cross-link interference (CLI) measurement resource in a full-duplex or sub-band full-duplex mode. For example, the communication and processing circuitry 1742 shown and described above in connection with FIG. 17 may provide a means to obtain the at least one signal.

At block 1804, the network entity may obtain a Layer 1 (L1) CLI report from a first UE including a plurality of CLI resource index fields, each configured to include a respective one of a plurality of CLI resource indexes, each identifying a different respective CLI measurement resource of the at least one CLI measurement resource, an absolute CLI indicator field configured to include an absolute CLI reported value associated with a first CLI resource index field of the plurality of CLI resource index fields, where the absolute CLI reported value is indicative of an absolute CLI level based on a reporting criteria, and a plurality of differential CLI indicator fields associated with additional CLI resource indexes of the plurality of CLI resource indexes, each configured to include a respective one of a plurality of differential CLI reported values, where each of the plurality of differential CLI reported values is indicative of a differential CLI level with respect to the absolute CLI level. For example, the CLI report processing circuitry 1744, together with the communication and processing circuitry 1742 and communication interface 1710, shown and described above in connection with FIG. 17, may provide a means to obtain the L1 CLI report.

In some examples, the absolute CLI reported value is a CLI sounding reference signal (SRS)-reference signal received power (RSRP) reported value and the differential CLI reported values are differential CLI SRS-RSRP reported values. In some examples, the absolute CLI reported value is a CLI-received signal strength indicator (RSSI) reported value and the differential CLI reported values are differential CLI-RSSI reported values. In some examples, the reporting criteria indicates a total number of CLI reported values including the absolute CLI reported value and the plurality of differential CLI reported values configured by the network entity based on a capability of the first UE. In some examples, the network entity may further obtain the capability of the first UE indicating a maximum number of CLI reported values supported by the first UE.

In some examples, the L1 CLI report includes a first CLI resource index within the first CLI resource index field, the absolute CLI reported value associated with the first CLI resource index in the absolute CLI indicator field, the additional CLI resource indexes in remaining CLI resource index fields of the plurality of CLI resource index fields, and the plurality of differential CLI reported values in the plurality of differential CLI indicator fields. In some examples, the reporting criteria requests reporting of a set of most interfering CLI measurement resources or a set of least interfering CLI measurement resources.

In some examples, at least a first reference signal of the at least one signal sent on a first CLI measurement resource of the at least one CLI measurement resource is an out-of-range signal having a signal strength outside of an absolute CLI level range. In this example, the L1 CLI report may further include at least a first CLI resource index identifying at least the first CLI measurement resource and at least a first CLI reported value associated with at least the first CLI resource index set to an out-of-range code bit. In some examples, the absolute CLI level range corresponds to a CLI-SRS-RSRP range or a CLI-RSSI range.

In some examples, the L1 CLI report further includes the first CLI resource index field including the first CLI resource index, the absolute CLI indicator field including the first CLI reported value, each remaining CLI resource index of the additional CLI resource indexes set to a respective dummy value, and each remaining differential CLI reported value of the plurality of differential CLI reported values set to a respective unused code bit. In some examples, the L1 CLI report further includes at least a second CLI resource index identifying at least a second CLI measurement resource having a second out-of-range signal associated therewith, and at least a first differential CLI reported value associated with at least the second CLI resource index set to the out-of-range code bit.

In some examples, the L1 CLI report may include the first CLI resource index field including the first CLI resource index, the absolute CLI indicator field including the first CLI reported value, each remaining CLI resource index of the additional CLI resource indexes set to a respective CLI resource index, and each remaining differential CLI reported value of the plurality of differential CLI reported values set to a respective differential code bit indicative of a respective differential CLI level with respect to a maximum absolute CLI level or a minimum absolute CLI level in the absolute CLI level range, where the absolute CLI level corresponds to the maximum absolute CLI level or the minimum absolute CLI level.

In some examples, the L1 CLI report may include the absolute CLI indicator field set to the absolute CLI level associated with an in-range signal of the at least one signal that is within the absolute CLI level range, the first CLI resource index field including an in-range CLI resource index associated with the absolute CLI reported value, at least a last CLI resource index field of the plurality of CLI resource index fields including at least the first CLI resource index, at least a last differential CLI indicator field of the plurality of differential CLI indicator fields including at least the first CLI reported value set to the out-of-range code bit, and remaining differential CLI reported values of the plurality of differential CLI reported values set to respective differential code bits indicative of respective differential CLI level with respect to the absolute CLI level.

In some examples, the L1 CLI report may include a bit indicating whether respective CLI resource indexes for one or more out-of-range signals are included in the L1 CLI report, each of the one or more out-of-range signals comprising a signal strength outside of an absolute CLI level range. In an example, the one or more out-of-range signals includes at least a first out-of-range signal associated with at least a first CLI measurement resource. In this example, the L1 CLI report may include at least the first CLI resource index field including at least a first CLI resource index identifying the first CLI measurement resource, each remaining CLI resource index of the additional CLI resource indexes set to a respective dummy value, and excluding the absolute CLI reported value and each of the plurality of differential CLI reported values.

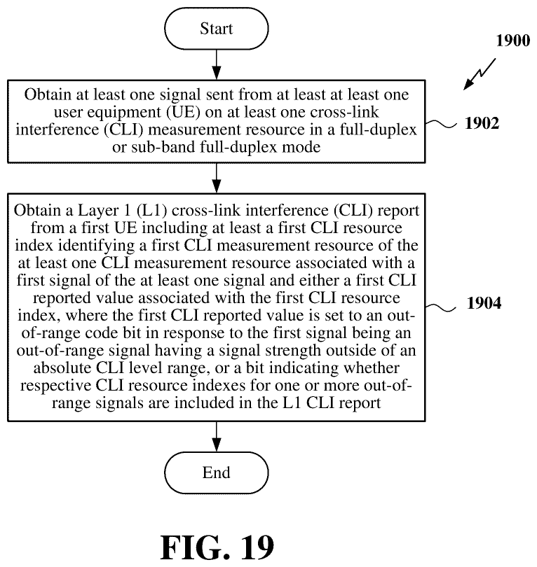

FIG. 19 is a flow chart of another exemplary process 1900 for exemplary process for cross-link interference reporting according to some aspects. As described below, some or all illustrated features may be omitted in a particular implementation within the scope of the present disclosure, and some illustrated features may not be required for implementation of all examples. In some examples, the process 1900 may be performed by the network entity 1700, as described above and illustrated in FIG. 17, by a processor or processing system, or by any suitable means for carrying out the described functions.

At block 1902, the network entity may obtain at least one signal sent from at least at least one user equipment (UE) on at least one cross-link interference (CLI) measurement resource in a full-duplex or sub-band full-duplex mode. For example, the communication and processing circuitry 1742 shown and described above in connection with FIG. 17 may provide a means to obtain the at least one signal.

At block 1904, the network entity may obtain a Layer 1 (L1) CLI report from a first UE including at least a first CLI resource index identifying a first CLI measurement resource of the at least one CLI measurement resource associated with a first signal of the at least one signal and either a first CLI reported value associated with the first CLI resource index, where the first CLI reported value is set to an out-of-range code bit in response to the first signal being an out-of-range signal having a signal strength outside of an absolute CLI level range, or a bit indicating whether respective CLI resource indexes for one or more out-of-range signals are included in the L1 CLI report. For example, the CLI report processing circuitry 1744, communication and processing circuitry 1742, and communication interface 1710, shown and described above in connection with FIG. 17, may provide a means to obtain the L1 CLI report.

In one configuration, the network entity 1700 includes means for obtaining at least one signal sent from at least at least one user equipment (UE) on at least one cross-link interference (CLI) measurement resource in a full-duplex or sub-band full-duplex mode and means for obtaining a layer 1 (L1) CLI report from a first UE including a plurality of CLI resource index fields, each configured to include a respective one of a plurality of CLI resource indexes, each identifying a different respective CLI measurement resource of the at least one CLI measurement resource, an absolute CLI indicator field configured to include an absolute CLI reported value associated with a first CLI resource index field of the plurality of CLI resource index fields, where the absolute CLI reported value is indicative of an absolute CLI level based on a reporting criteria, and a plurality of differential CLI indicator fields associated with additional CLI resource indexes of the plurality of CLI resource indexes, each configured to include a respective one of a plurality of differential CLI reported values, where each of the plurality of differential CLI reported values is indicative of a differential CLI level with respect to the absolute CLI level, as described in the present disclosure. In one aspect, the aforementioned means may be the processor 1704 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable storage medium 1706, or any other suitable apparatus or means described in any one of the FIGS. 1, 2, and/or 5-7 utilizing, for example, the processes and/or algorithms described herein in relation to FIGS. 18 and 19.

The processes shown in FIGS. 15, 16, 18, and 19 may include additional aspects, such as any single aspect or any combination of aspects described below and/or in connection with one or more other processes described elsewhere herein.

Aspect 1: A method for wireless communication at a user equipment (UE), the method comprising: measuring cross-link interference (CLI) caused by transmission of at least one signal sent from at least one additional UE on at least one CLI measurement resource in a full-duplex or sub-band full-duplex mode; and transmitting a layer 1 (L1) CLI report to a network entity, wherein the L1 CLI report comprises: an absolute CLI indicator field configured to include an absolute CLI reported value associated with a first CLI resource index field identifying one of the at least one CLI measurement resource, where the absolute CLI reported value is indicative of an absolute CLI level based on a reporting criteria. The L1 CLI report further includes, responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, where each of the at least one differential CLI reported value is indicative of a differential CLI level with respect to the absolute CLI level.

Aspect 2: The method of aspect 1, wherein the absolute CLI reported value comprises a CLI sounding reference signal (SRS)-reference signal received power (RSRP) reported value and the at least one differential CLI reported value comprise differential CLI SRS-RSRP reported values or the absolute CLI reported value comprises a CLI-received signal strength indicator (RSSI) reported value and the at least one differential CLI reported value comprise differential CLI-RSSI reported values.

Aspect 3: The method of aspect 1 or 2, wherein the reporting criteria requests reporting of a set of most interfering CLI measurement resources or a set of least interfering CLI measurement resources.

Aspect 4: The method of any of aspects 1 through 3, wherein the L1 CLI report comprises at least one CLI resource index field comprising the first CLI resource index field and the at least one additional CLI resource index field, each of the at least one CLI resource index field configured to include a respective one of at least one CLI resource index, each of the at least one CLI resource index identifying a different respective CLI measurement resource of the at least one CLI measurement resource.

Aspect 5: The method of aspect 4, wherein the L1 CLI report comprises a first CLI resource index within the first CLI resource index field, the absolute CLI reported value associated with the first CLI resource index in the absolute CLI indicator field, at least one additional CLI resource index in the at least one additional CLI resource index field, and the at least one differential CLI reported value in the at least one differential CLI indicator field, wherein the at least one differential CLI reported value comprises a plurality of differential CLI reported values.

Aspect 6: The method of aspect 4 or 5, wherein at least a first reference signal of the at least one signal sent on a first CLI measurement resource of the at least one CLI measurement resource is an out-of-range signal comprising a signal strength outside an absolute CLI level range, wherein the L1 CLI report comprises at least a first CLI resource index identifying at least the first CLI measurement resource and at least a first CLI reported value associated with at least the first CLI resource index set to an out-of-range code bit.

Aspect 7: The method of any of aspect 6, wherein the absolute CLI level range corresponds to a CLI-SRS-RSRP range or a CLI-RSSI range.

Aspect 8: The method of aspect 6 or 7, wherein the first CLI resource index field includes the first CLI resource index, the absolute CLI indicator field includes the first CLI reported value, each of the at least one additional CLI resource index field is set to a respective dummy value, and each of the at least one differential CLI reported value is set to a respective unused code bit.

Aspect 9: The method aspect 8, wherein the L1 CLI report further comprises at least a second CLI resource index identifying at least a second CLI measurement resource having a second out-of-range signal associated therewith, and at least a first differential CLI reported value associated with at least the second CLI resource index set to the out-of-range code bit.

Aspect 10: The method of aspect 8 or 9, wherein the out-of-range code bit and the unused code bit are selected from a table of absolute CLI reported values and corresponding absolute CLI levels with 1 dB resolution.

Aspect 11: The method of aspect 10, wherein the signal strength is lower than a minimum absolute CLI level in the absolute CLI level range, and the out-of-range code bit is associated with a lowest absolute CLI reported value in the table.

Aspect 12: The method of aspect 6 or 7, wherein each of the at least one differential CLI reported value is set to a respective differential code bit indicative of a respective differential CLI level with respect to a maximum absolute CLI level or a minimum absolute CLI level in the absolute CLI level range, wherein the absolute CLI level corresponds to the maximum absolute CLI level or the minimum absolute CLI level.

Aspect 13: The method of aspect 6 or 7, wherein the L1 CLI report comprises the absolute CLI indicator field set to the absolute CLI level associated with an in-range signal of the at least one signal that is within the absolute CLI level range, the first CLI resource index field including an in-range CLI resource index associated with the absolute CLI reported value, at least a last CLI resource index field of the at least one CLI resource index field including at least the first CLI resource index, at least a last differential CLI indicator field of the at least one differential CLI indicator field including at least the first CLI reported value set to the out-of-range code bit, and additional differential CLI reported values of the at least one differential CLI reported value set to respective differential code bits indicative of respective differential CLI level with respect to the absolute CLI level.

Aspect 14: The method of aspect 13, wherein the out-of-range code bit is selected from a table of differential CLI reported values, each representing a range with 2 dB resolution of differential CLI levels with respect to the absolute CLI level and each comprising four bits.

Aspect 15: The method of aspect 13, wherein the out-of-range code bit is selected from a table of differential CLI reported values, each representing a range with 2 dB resolution of differential CLI levels with respect to the absolute CLI level and each comprising five bits.

Aspect 16: The method of aspect 4, wherein the L1 CLI report further comprises a bit indicating whether respective CLI resource indexes for one or more out-of-range signals are included in the L1 CLI report, each of the one or more out-of-range signals comprising a signal strength outside of an absolute CLI level range.

Aspect 17: The method of aspect 16, wherein the one or more out-of-range signals comprises at least a first out-of-range signal associated with at least a first CLI measurement resource, and wherein the L1 CLI report comprises at least the first CLI resource index field including at least a first CLI resource index identifying the first CLI measurement resource, each of the at least one additional CLI resource index field is set to a respective dummy value, and excluding the absolute CLI reported value and the at least one differential CLI reported value.

Aspect 18: The method of any of aspects 1 through 17, wherein the reporting criteria indicates a total number of CLI reported values including the absolute CLI reported value and the plurality of differential CLI reported values configured by the network entity based on a capability of the UE.

Aspect 19: The method of aspect 18, further comprising: transmitting, to the network entity, the capability of the UE indicating a maximum number of CLI reported values supported by the UE.

Aspect 20: A method operable at a network entity, the method comprising: obtaining at least one signal sent from at least at least one user equipment (UE) on at least one cross-link interference (CLI) measurement resource in a full-duplex or sub-band full-duplex mode; and obtaining a Layer 1 (L1) CLI report from a first UE, wherein the L1 CLI report comprises: a plurality of CLI resource index fields, each configured to include a respective one of a plurality of CLI resource indexes, each identifying a different respective CLI measurement resource of the at least one CLI measurement resource, an absolute CLI indicator field configured to include an absolute CLI reported value associated with a first CLI resource index field of the plurality of CLI resource index fields, wherein the absolute CLI reported value is indicative of an absolute CLI level based on a reporting criteria, and a plurality of differential CLI indicator fields associated with additional CLI resource indexes of the plurality of CLI resource indexes, each configured to include a respective one of a plurality of differential CLI reported values, wherein each of the plurality of differential CLI reported values is indicative of a differential CLI level with respect to the absolute CLI level.

Aspect 21: The method of aspect 20, wherein the absolute CLI reported value comprises a CLI sounding reference signal (SRS)-reference signal received power (RSRP) reported value and the plurality of differential CLI reported values comprise differential CLI SRS-RSRP reported values.

Aspect 22: The method of aspect 20, wherein the absolute CLI reported value comprises a CLI-received signal strength indicator (RSSI) reported value and the plurality of differential CLI reported values comprise differential CLI-RSSI reported values.

Aspect 23: The method of any of aspects 20 through 22, wherein the reporting criteria requests reporting of a set of most interfering CLI measurement resources or a set of least interfering CLI measurement resources.

Aspect 24: The method of any of aspects 20-23, wherein the obtaining the L1 CLI report further comprises: transmitting the L1 CLI report comprising a first CLI resource index within the first CLI resource index field, the absolute CLI reported value associated with the first CLI resource index in the absolute CLI indicator field, the additional CLI resource indexes in remaining CLI resource index fields of the plurality of CLI resource index fields, and the plurality of differential CLI reported values in the plurality of differential CLI indicator fields.

Aspect 25: The method of any of aspects 20-23, wherein at least a first reference signal of the at least one signal sent on a first CLI measurement resource of the at least one CLI measurement resource is an out-of-range signal comprising a signal strength outside of an absolute CLI level range, wherein the obtaining the L1 CLI report further comprises: obtaining the L1 CLI report comprising at least a first CLI resource index identifying at least the first CLI measurement resource and at least a first CLI reported value associated with at least the first CLI resource index set to an out-of-range code bit.

Aspect 26: The method of aspect 25, wherein the absolute CLI level range corresponds to a CLI-SRS-RSRP range or a CLI-RSSI range.

Aspect 27: The method of aspect 25 or 26, wherein the obtaining the L1 CLI report further comprises: obtaining the L1 CLI report further comprising the first CLI resource index field including the first CLI resource index, the absolute CLI indicator field including the first CLI reported value, each remaining CLI resource index of the additional CLI resource indexes set to a respective dummy value, and each remaining differential CLI reported value of the plurality of differential CLI reported values set to a respective unused code bit.

Aspect 28: The method of aspect 27, wherein the obtaining the L1 CLI report further comprises: obtaining the L1 CLI report further comprising at least a second CLI resource index identifying at least a second CLI measurement resource having a second out-of-range signal associated therewith, and at least a first differential CLI reported value associated with at least the second CLI resource index set to the out-of-range code bit.

Aspect 29: The method of aspect 25 or 26, wherein the obtaining the L1 CLI report further comprises: obtaining the L1 CLI report further comprising the first CLI resource index field including the first CLI resource index, the absolute CLI indicator field including the first CLI reported value, each remaining CLI resource index of the additional CLI resource indexes set to a respective CLI resource index, and each remaining differential CLI reported value of the plurality of differential CLI reported values set to a respective differential code bit indicative of a respective differential CLI level with respect to a maximum absolute CLI level or a minimum absolute CLI level in the absolute CLI level range, wherein the absolute CLI level corresponds to the maximum absolute CLI level or the minimum absolute CLI level.

Aspect 30: The method of aspect 25 or 26, wherein the obtaining the L1 CLI report further comprises: obtaining the L1 CLI report comprising the absolute CLI indicator field set to the absolute CLI level associated with an in-range signal of the at least one signal that is within the absolute CLI level range, the first CLI resource index field including an in-range CLI resource index associated with the absolute CLI reported value, at least a last CLI resource index field of the plurality of CLI resource index fields including at least the first CLI resource index, at least a last differential CLI indicator field of the plurality of differential CLI indicator fields including at least the first CLI reported value set to the out-of-range code bit, and remaining differential CLI reported values of the plurality of differential CLI reported values set to respective differential code bits indicative of respective differential CLI level with respect to the absolute CLI level.

Aspect 31: The method of any of aspects 20-23, wherein the obtaining the L1 CLI report further comprises: obtaining the L1 CLI report comprising a bit indicating whether respective CLI resource indexes for one or more out-of-range signals are included in the L1 CLI report, each of the one or more out-of-range signals comprising a signal strength outside of an absolute CLI level range.

Aspect 32: The method of aspect 31, wherein the one or more out-of-range signals comprises at least a first out-of-range signal associated with at least a first CLI measurement resource, and wherein the obtaining the L1 CLI report further comprises: obtaining the L1 CLI report comprising at least the first CLI resource index field including at least a first CLI resource index identifying the first CLI measurement resource, each remaining CLI resource index of the additional CLI resource indexes set to a respective dummy value, and excluding the absolute CLI reported value and each of the plurality of differential CLI reported values.

Aspect 33: The method of any of aspects 20-32 further comprising: providing the reporting criteria indicating a total number of CLI reported values including the absolute CLI reported value and the plurality of differential CLI reported values configured by the network entity based on a capability of the UE.

Aspect 34: The method of aspect 33, further comprising: obtaining the capability of the first UE indicating a maximum number of CLI reported values supported by the UE.

Aspect 35: An apparatus operable at a user equipment (UE) comprising one or more memories, a transceiver, and one or more processors coupled to the one or more memories, wherein the one or more processors are configured to perform a method of any of aspects 1 through 19.

Aspect 36: An apparatus comprising means for performing a method of any of aspects 1 through 19.

Aspect 37: A non-transitory computer-readable medium having stored therein instructions executable by one or more processors of a user equipment (UE) to perform a method of any one of aspects 1 through 19.

Aspect 38: An apparatus operable at a network entity comprising one or more memories and one or more processors coupled to the one or more memories, wherein the one or more processors are configured to perform a method of any of aspects 20 through 34.

Aspect 39: An apparatus comprising means for performing a method of any of aspects 20 through 34.

Aspect 40: A non-transitory computer-readable medium having stored therein instructions executable by one or more processors of a network entity to perform a method of any one of aspects 20 through 34.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, and/or 5-7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus operable at a user equipment (UE), comprising:
one or more memories;
a transceiver; and
one or more processors coupled to the one or more memories, wherein the one or more processors are configured to:
measure cross-link interference (CLI) caused by transmission of at least one signal sent from at least one additional UE on at least one CLI measurement resource in a full-duplex or sub-band full-duplex mode; and
transmit, via the transceiver, a Layer 1 (L1) CLI report to a network entity, wherein the L1 CLI report comprises:
an absolute CLI indicator field configured to include an absolute CLI reported value associated with a first CLI resource index field identifying one of the at least one CLI measurement resource, wherein the absolute CLI reported value is indicative of an absolute CLI level based on a reporting criteria, and
responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, wherein each of the at least one differential CLI reported value is indicative of a differential CLI level with respect to the absolute CLI level.

2. The apparatus of claim 1, wherein the absolute CLI reported value comprises a CLI sounding reference signal (SRS)-reference signal received power (RSRP) reported value and the at least one differential CLI reported value comprise differential CLI SRS-RSRP reported values or the absolute CLI reported value comprises a CLI-received signal strength indicator (RSSI) reported value and the at least one differential CLI reported value comprise differential CLI-RSSI reported values.

3. The apparatus of claim 1, wherein the reporting criteria requests reporting of a set of most interfering CLI measurement resources or a set of least interfering CLI measurement resources.

4. The apparatus of claim 1, wherein the L1 CLI report comprises at least one CLI resource index field comprising the first CLI resource index field and the at least one additional CLI resource index field, each of the at least one CLI resource index field configured to include a respective one of at least one CLI resource index, each of the at least one CLI resource index identifying a different respective CLI measurement resource of the at least one CLI measurement resource.

5. The apparatus of claim 4, wherein the L1 CLI report comprises a first CLI resource index within the first CLI resource index field, the absolute CLI reported value associated with the first CLI resource index in the absolute CLI indicator field, at least one additional CLI resource index in the at least one additional CLI resource index field, and the at least one differential CLI reported value in the at least one differential CLI indicator field, wherein the at least one differential CLI reported value comprises a plurality of differential CLI reported values.

6. The apparatus of claim 4, wherein at least a first reference signal of the at least one signal sent on a first CLI measurement resource of the at least one CLI measurement resource is an out-of-range signal comprising a signal strength outside an absolute CLI level range, wherein the L1 CLI report comprises at least a first CLI resource index identifying at least the first CLI measurement resource and at least a first CLI reported value associated with at least the first CLI resource index set to an out-of-range code bit.

7. The apparatus of claim 6, wherein the absolute CLI level range corresponds to a CLI-SRS-RSRP range or a CLI-RSSI range.

8. The apparatus of claim 6, wherein the first CLI resource index field includes the first CLI resource index, the absolute CLI indicator field includes the first CLI reported value, each of the at least one additional CLI resource index field is set to a respective dummy value, and each of the at least one differential CLI reported value is set to a respective unused code bit.

9. The apparatus of claim 8, wherein the L1 CLI report further comprises at least a second CLI resource index identifying at least a second CLI measurement resource having a second out-of-range signal associated therewith, and at least a first differential CLI reported value associated with at least the second CLI resource index set to the out-of-range code bit.

10. The apparatus of claim 8, wherein the out-of-range code bit and the unused code bit are selected from a table of absolute CLI reported values and corresponding absolute CLI levels with 1 dB resolution.

11. The apparatus of claim 10, wherein the signal strength is lower than a minimum absolute CLI level in the absolute CLI level range and the out-of-range code bit is associated with a lowest absolute CLI reported value in the table.

12. The apparatus of claim 6, wherein each of the at least one differential CLI reported value is set to a respective differential code bit indicative of a respective differential CLI level with respect to a maximum absolute CLI level or a minimum absolute CLI level in the absolute CLI level range, wherein the absolute CLI level corresponds to the maximum absolute CLI level or the minimum absolute CLI level.

13. The apparatus of claim 6, wherein the L1 CLI report comprises the absolute CLI indicator field set to the absolute CLI level associated with an in-range signal of the at least one signal that is within the absolute CLI level range, the first CLI resource index field including an in-range CLI resource index associated with the absolute CLI reported value, at least a last CLI resource index field of the at least one CLI resource index field including at least the first CLI resource index, at least a last differential CLI indicator field of the at least one differential CLI indicator field including at least the first CLI reported value set to the out-of-range code bit, and additional differential CLI reported values of the at least one differential CLI reported value set to respective differential code bits indicative of respective differential CLI level with respect to the absolute CLI level.

14. The apparatus of claim 13, wherein the out-of-range code bit is selected from a table of differential CLI reported values, each representing a range with 2 dB resolution of differential CLI levels with respect to the absolute CLI level and each comprising four bits.

15. The apparatus of claim 13, wherein the out-of-range code bit is selected from a table of differential CLI reported values, each representing a range with 2 dB resolution of differential CLI levels with respect to the absolute CLI level and each comprising five bits.

16. The apparatus of claim 4, wherein the L1 CLI report further comprises a bit indicating whether respective CLI resource indexes for one or more out-of-range signals are included in the L1 CLI report, each of the one or more out-of-range signals comprising a signal strength outside of an absolute CLI level range.

17. The apparatus of claim 16, wherein the one or more out-of-range signals comprises at least a first out-of-range signal associated with at least a first CLI measurement resource, and wherein the L1 CLI report comprises at least the first CLI resource index field including at least a first CLI resource index identifying the first CLI measurement resource, each of the at least one additional CLI resource index field is set to a respective dummy value, and excluding the absolute CLI reported value and the at least one differential CLI reported value.

18. The apparatus of claim 1, wherein the reporting criteria indicates a total number of CLI reported values including the absolute CLI reported value and the at least one differential CLI reported value configured by the network entity based on a capability of the UE.

19. A method for wireless communication at a user equipment (UE), the method comprising:
measuring cross-link interference (CLI) caused by transmission of at least one signal sent from at least one additional UE on at least one CLI measurement resource in a full-duplex or sub-band full-duplex mode; and
transmitting a Layer 1 (L1) CLI report to a network entity, wherein the L1 CLI report comprises:
an absolute CLI indicator field configured to include an absolute CLI reported value associated with a first CLI resource index field identifying one of the at least one CLI measurement resource, wherein the absolute CLI reported value is indicative of an absolute CLI level based on a reporting criteria, and
responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, wherein each of the at least one differential CLI reported value is indicative of a differential CLI level with respect to the absolute CLI level.

20. An apparatus at a user equipment (UE), comprising:
means for measuring cross-link interference (CLI) caused by transmission of at least one signal sent from at least one additional UE on at least one CLI measurement resource in a full-duplex or sub-band full-duplex mode; and
means for transmitting a Layer 1 (L1) CLI report to a network entity, wherein the L1 CLI report comprises:
an absolute CLI indicator field configured to include an absolute CLI reported value associated with a first CLI resource index field identifying one of the at least one CLI measurement resource, wherein the absolute CLI reported value is indicative of an absolute CLI level based on a reporting criteria, and
responsive to the at least one CLI measurement resource comprising a plurality of CLI measurement resources, at least one differential CLI indicator field configured to include at least one differential CLI reported value associated with at least one additional CLI resource index field, each identifying an additional one of the at least one CLI measurement resource, wherein each of the at least one differential CLI reported value is indicative of a differential CLI level with respect to the absolute CLI level.
